(19) United States
(12) Patent Application Publication
(10) Pub. No.: US 2013/0187610 A1
(43) Pub. Date: Jul. 25, 2013

(54) CHARGING/DISCHARGING MONITORING DEVICE AND BATTERY PACK

(71) Applicant: HITACHI ULSI SYSTEMS CO., LTD., Tokyo (JP)

(72) Inventors: Hirokatsu HAYASHI, Kodaira (JP); Hiroyuki KATO, Higashiyamato (JP); Hidetomo AOYAGI, Hamura (JP); Hitoshi ENDO, Hachioji (JP)

(73) Assignee: HITACHI ULSI SYSTEMS CO., LTD., Tokyo (JP)

(21) Appl. No.: 13/749,279

(22) Filed: Jan. 24, 2013

(30) Foreign Application Priority Data
Jan. 25, 2012 (JP) 2012-013072

(51) Int. Cl. H02J 7/00

(52) U.S. Cl. CPC H02J 7/00
USPC 320/118

(57) ABSTRACT

A charging/discharging monitoring device of a battery pack, includes: a plurality of monitoring integrated circuits; a plurality of wiring boards on which the plurality of monitoring integrated circuits are mounted, respectively; and a plurality of signal transmission paths for, via corresponded respective capacitors, connecting between the plurality of wiring boards. The charging/discharging monitoring device is configured with a two-wire transmission path for connecting between terminals of an upstream-side monitoring integrated circuit of daisy chain connection and a downstream-side monitoring integrated circuit thereof, and a wire length of a wiring part which connects between the respective capacitors and terminals of the corresponding monitoring integrated circuits on the wiring boards is a length in which resonance is not caused by the electromagnetic wave noises in an electromagnetic wave noise environment under which the wiring boards are arranged.

### CROSS-REFERENCE TO RELATED APPLICATION

The present application claims priority from Japanese Patent Application No. 2012-013072 filed on Jan. 25, 2012, the content of which is hereby incorporated by reference into this application.

### TECHNICAL FIELD OF THE INVENTION

The present invention relates to a charging/discharging monitoring device. For example, the present invention relates to a technology effectively applicable to one in which a signal is transmitted between paired semiconductor integrated circuit units each connected to a different reference potential or driving potential from the other, such as a charging/discharging monitoring device for a battery pack formed by connecting a plurality of secondary or rechargeable battery cells in series in multistage.

### BACKGROUND OF THE INVENTION

For example, Patent Document 1 (Japanese Patent Application Laid-Open Publication No. 2010-63334) discloses a charge state control device of an assembled battery for solving a variation of cell batteries in a plurality of block batteries. In this Patent Document 1, as an device which controls a charge state of an assembled battery formed by connecting a plurality of block batteries in series each of which is formed by connecting a plurality of unit cells each including a secondary battery in series, a monitoring circuit is arranged for every block battery, and a discharge circuit which detects a battery voltage to be adjusted to the lowest cell potential is provided.

### SUMMARY OF THE INVENTION

Incidentally, as in the above-described Patent Document 1, in a monitoring circuit which corresponds to each adjacent block battery, a data transmission method through an electrical current is used in daisy-chain transmission between upstream and downstream blocks, or a data transmission method is used in which a voltage level of a transmission signal is adjusted between a transmission side and a reception side by using either one of upstream and downstream power sources. In such a daisy-chain transmission between the upstream and the downstream, devices are not insulated from each other in direct current, and therefore, this includes a risk that destruction of one device (IC) directly affects the other device (IC) to be destroyed. Also, this includes such a problem that a transmission line between devices is as an antenna to be affected by exogenous electromagnetic-wave noises, which results in a malfunction and difficulty of extension of a transmission distance between the devices.

Accordingly, the present invention has been made in consideration of the problems as described above, and a typical preferred aim of this is to provide a charging/discharging monitoring device in which the influence of the exogenous electromagnetic-wave noises can be excluded and in which the transmission distance can be extended, and besides, in which influence to/from a counterpart in direct current transmission can be excluded.

The above and other preferred aims and novel characteristics of the present invention will be apparent from the description of the present specification and the accompanying drawings.

The typical ones of the inventions disclosed in the present application will be briefly described as follows.

That is, a typical charging/discharging monitoring device is a charging/discharging monitoring device for monitoring charging/discharging state of a battery pack formed by connecting a plurality of sets in series in multistage, the sets each formed by connecting a plurality of battery cells in series, and has the following features.

The charging/discharging monitoring device for use with a battery pack includes a plurality of wiring boards electrically connected by signal transmission paths. Each of the wiring boards includes a semiconductor integrated circuit unit formed with a monitoring circuit configured to monitor voltage variation of battery cells in the battery pack, a reception circuit to which differential data is inputted, and a transmission circuit from which differential data is outputted.

The internal connection terminals in the reception circuit and the transmission circuit are electrically coupled with corresponding external connection terminals formed on the wiring board through capacitors, respectively. The respective external connection terminals are connected to corresponding predetermined potentials through corresponding resistors.

In the battery pack, the signal transmission paths are arranged across spaces or gaps between the wiring boards so as to provide signal transmission lines among the wiring boards or the semiconductor integrated circuit units. The respective signal transmission paths include conductive lines and are arranged to electrically connect the semiconductor integrated circuit units in daisy chain connection.

Each of the signal transmission paths is configured with first and second two-wire transmission paths. The first two-wire transmission path provides transmission lines through which an output from the semiconductor integrated circuit unit on an upstream side of the daisy chain connection is transmitted via the corresponded capacitor to the semiconductor integrated circuit unit on a downstream side of the daisy chain connection, and the second two-wire transmission path provides transmission lines through which an output from the semiconductor integrated circuit unit on the downstream side of the daisy chain connection is transmitted to the semiconductor integrated circuit unit on the upstream side of the daisy chain connection via the corresponded capacitor.

And, on the respective wiring boards, a wire length of each wiring part, in which each wiring part connects the capacitor with the corresponding internal connection terminal, is configured to have such a length as to hinder resonance from being caused against electromagnetic wave noises in an electromagnetic wave noise environment under which the wiring board is arranged.

Also, another typical charging/discharging monitoring device is a charging/discharging monitoring device for monitoring charging/discharging state of a battery pack formed by connecting a plurality of sets in series in multistage, the sets each formed by connecting a plurality of battery cells in series, and has the following features.

The charging/discharging monitoring device for use with the battery pack includes a plurality of circuit units electrically connected by signal transmission paths. Each of the circuit units includes a semiconductor integrated circuit formed with a monitoring circuit arranged so as to monitor voltage variation of battery cells in the battery pack, a reception circuit to which differential data is inputted, and a transmission circuit from which differential data is outputted.

The internal connection terminals in the reception circuit and the transmission circuit are electrically coupled with corresponding external connection terminals formed on the circuit units through capacitors, respectively. The respective external connection terminals are connected to corresponding predetermined direct-current potentials through corresponding resistors.

In the battery pack, the signal transmission paths are arranged across spaces between the circuit units so as to provide signal transmission lines among the circuit units or the semiconductor integrated circuit units. The respective signal transmission paths include conductive lines and are arranged to electrically connect the semiconductor integrated circuits in daisy chain connection.

Each of the signal transmission paths is configured with first and second two-wire transmission paths. The first two-wire transmission path provides transmission lines through which an output from the semiconductor integrated circuit on an upstream side of the daisy chain connection is transmitted to the semiconductor integrated circuit on a downstream side of the daisy chain connection via the corresponded capacitor, and the second two-wire transmission path provides transmission lines through which an output from the semiconductor integrated circuit on the downstream side of the daisy chain connection is transmitted to the semiconductor integrated circuit on the upstream side of the daisy chain connection via the corresponded capacitor.

And, on the respective circuit units, a wire length of each wiring part, in which the respective wiring part connects the capacitor with the corresponding internal connection terminal, is configured to have such a length as to hinder resonance from being caused against electromagnetic wave noises in an electromagnetic wave noise environment under which the circuit unit is arranged.

Further, the present invention can be also configured as a battery pack in which the charging/discharging state of the battery cells connected in series is monitored by the charging/discharging monitoring device.

The effects obtained by typical aspects of the present invention will be briefly described below.

That is, because of a unique circuit configuration installed on the two-wire transmission paths, in which each signal transmission path electrically connecting circuit units is isolated with respect to a DC-current, the typical charging/discharging monitoring device has effects that the influence of the exogenous electromagnetic wave noises can be prevented and that the transmission distance can be extended, and besides, that the influence to/from the transmission counterpart in direct current can be excluded.

### BRIEF DESCRIPTIONS OF THE DRAWINGS

FIG. 1 illustrates a schematic block diagram of an embodiment of a battery pack to which a charging/discharging monitoring device of the present invention is applied;

FIG. 2 illustrates a block diagram of an embodiment for explaining a monitoring circuit mounted on a monitoring integrated circuit in FIG. 1 in detail;

FIG. 3 illustrates a block diagram of an embodiment of a data reception circuit (clock reception circuit) provided in a monitoring integrated circuit according to the present invention;

FIG. 4 illustrates a block diagram of another embodiment of the data reception circuit (clock reception circuit) provided in the monitoring integrated circuit according to the present invention;

FIG. 5 illustrates an explanatory diagram of a two-wire transmission path connected to a data reception circuit (clock reception circuit) and a data transmission circuit (clock transmission circuit) provided in the monitoring integrated circuit according to the present invention;

FIGS. 6A and 6B illustrate explanatory diagrams of an embodiment of a data transmission circuit (clock transmission circuit) provided in the monitoring integrated circuit according to the present invention;

FIGS. 7A and 7B illustrate explanatory diagrams of another embodiment of a data transmission circuit (clock transmission circuit) provided in the monitoring integrated circuit according to the present invention;

FIGS. 8A and 8B illustrate explanatory diagrams of an embodiment of a data reception circuit (clock reception circuit) provided in the monitoring integrated circuit according to the present invention;

FIG. 9 illustrates a schematic block diagram of another embodiment of the battery pack to which the charging/discharging monitoring device of the present invention is applied;

FIG. 10 illustrates a schematic block diagram of still another embodiment of the battery pack to which the charging/discharging monitoring device of the present invention is applied;

FIG. 11 illustrates a schematic block diagram of still another embodiment of the battery pack to which the charging/discharging monitoring device of the present invention is applied;

FIG. 12 illustrates a schematic block diagram of a configuration of resistive connection in a 2-series capacitive coupling of a more preferable embodiment of the battery pack to which the charging/discharging monitoring device of the present invention is applied;

FIG. 13 illustrates a schematic block diagram of another configuration of the resistive connection in the 2-series capacitive coupling of the more preferable embodiment of the battery pack to which the charging/discharging monitoring device of the present invention is applied;

FIG. 14 illustrates a circuit diagram of a configuration in two-way communication performed by a CML circuit of a more preferable embodiment of the battery pack to which the charging/discharging monitoring device of the present invention is applied;

FIGS. 15A and 15B illustrate signal waveform diagrams of the configuration in the two-way communication performed by the CML circuit in FIG. 14;

FIG. 16 illustrates a circuit diagram of a configuration having an embedded CML circuit and TTL circuit of a more preferable embodiment of the battery pack to which the charging/discharging monitoring device of the present invention is applied;

FIG. 17 illustrates a mode explanatory diagram of the configuration having the embedded CML circuit and TTL circuit in FIG. 16;

FIG. 18 illustrates a circuit diagram of a TTL two-way communication circuit of the configuration having the embedded CML circuit and TTL circuit in FIG. 16;

FIG. 19 illustrates a signal waveform diagram of communication between the TTL two-way communication circuits of the configuration having the embedded CML circuit and TTL circuit in FIG. 18;

FIG. 20 illustrates a signal waveform diagram of communication between the TTL two-way communication circuits of the configuration having the embedded CML circuit and TTL circuit in FIG. 18;

FIG. 21 illustrates an explanatory diagram of a communication procedure of a communication protocol of a more preferable embodiment of the battery pack to which the charging/discharging monitoring device of the present invention is applied;

FIG. 22 illustrates an explanatory diagram of a signal configuration of the communication protocol in FIG. 21;

FIG. 23 illustrates a circuit diagram of a configuration of overvoltage protection by a zener diode of a more preferable embodiment of the battery pack to which the charging/discharging monitoring device of the present invention is applied;

FIG. 24 illustrates a circuit diagram of a one-way communication format of a more preferable embodiment of the battery pack to which the charging/discharging monitoring device of the present invention is applied;

FIG. 25 illustrates a circuit diagram of a configuration which enhances noise resistance of a more preferable embodiment of the battery pack to which the charging/discharging monitoring device of the present invention is applied; and

FIG. 26 illustrates a signal waveform diagram of the configuration which enhances the noise resistance in FIG. 25.

### DESCRIPTIONS OF THE PREFERRED EMBODIMENTS

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, in the embodiments described below, when referring to the number of elements (including number of pieces, values, amount, range, and the like), the number of the elements is not limited to a specific number unless otherwise stated or except the case where the number is apparently limited to a specific number in principle. The number larger or smaller than the specific number is also applicable.

Further, in the embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are described, the substantially approximate and similar shapes and the like are included therein unless otherwise stated or except the case where it is conceivable that they are apparently excluded in principle. The same goes for the numerical value and the range described above.

Hereinafter, embodiments of the present invention will be described in detail with reference to the accompanying drawings. Note that the same members are denoted by the same reference symbols throughout all drawings for describing the embodiments, and the repetitive description thereof will be omitted.

### First Embodiment

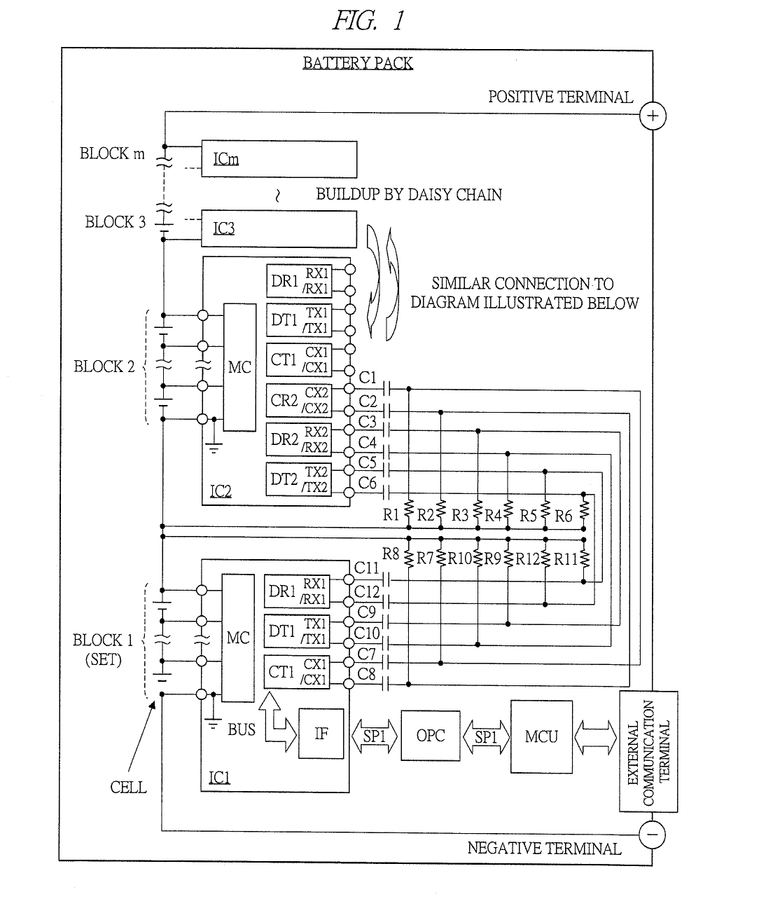

A first embodiment to which a charging/discharging monitoring device of the present invention is applied will be explained with reference to FIGS. 1 to 11.

<Configuration of Battery Pack>

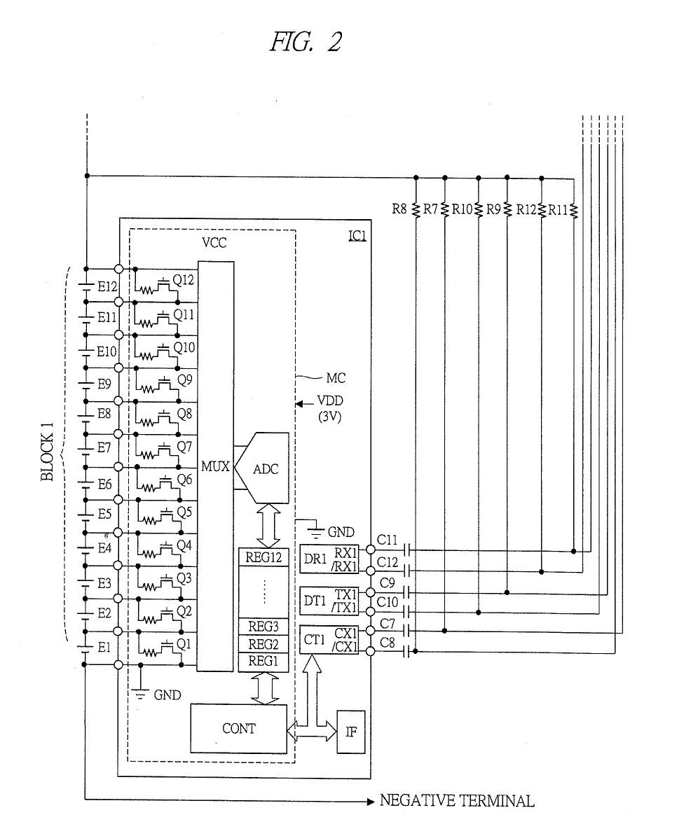

FIG. 1 illustrates a schematic block diagram of an embodiment of a battery pack to which a charging/discharging monitoring device of the present invention is applied. A plurality of battery cells are connected in a series format between a positive terminal “+” of the battery pack and a negative terminal “−” thereof. Although not particularly limited, each of the above-described plurality of battery cells is of a lithium-ion secondary battery cell. In the plurality of lithium-ion batteries in the series configuration, a plurality thereof form one block (set), and such “m” blocks as a block 1 to a block “m” are formed. As illustrated in, for example, FIG. 2 described later, one block is formed of 12 battery cells.

When the battery pack of the present embodiment is used for driving a motor of an electric vehicle (EV) or a hybrid electric vehicle (HEV) combined with a gasoline (petrol) engine, the block 1 to the block “m” described above is formed of, for example, eight blocks as the block 1 to the block 8. A battery voltage of one battery cell is about 4.2 V (volt), and therefore, a both-end voltage of one block is about 50.4 V, so that a high voltage of about 400 V is generated in the whole battery pack. However, the battery cell is the secondary battery, and each voltage is changed by a charging operation and a discharging operation, and therefore, the battery voltage in the whole battery pack also is changed in accordance with them.

In corresponding to each of the block 1 to the block “m”, monitoring integrated circuits “IC1” to “ICm” are provided. Each monitoring integrated circuit “IC” receives the battery voltage of the 12 battery cells as described above, and includes such an element as having a relatively high breakdown voltage as about 60 V in consideration of the highest voltage of the battery cell. Each monitoring integrated circuit IC can be formed on a single semiconductor substrate, or can be formed of a plurality of semiconductor chips with different functions from each other mounted thereon. A “semiconductor integrated circuit unit” in the following description is used as a collective designation for both a case that it is formed of a single semiconductor integrated circuit chip and a case that it is formed as a module in which a plurality of semiconductor chips are integrally mounted on a circuit board.

As also in the above-described Patent Document 1, in a charge state of each cell, one which is greatly different from the charge state of other cell is caused by repeating a charging/discharging cycle. When the cell which is different in the charge state exists as described above, the state of the cell falls into a deep discharge state depending on a case, and there is a risk of causing malfunction of the whole battery pack. For preventing such a situation, the charging/discharging monitoring device which is formed of the monitoring integrated circuits IC1 to ICm described above monitors individually a terminal voltage of each cell to determine the charge state. Also, it has a function which individually charges and discharges each cell to balance SOC (State Of Charge) of each cell.

Incidentally, an energy capacity of a battery is defined generally by a total charge which can be supplied until the above-described charge state (SOC) of the battery changes from 100% to 0%. However, as already known, when a battery is charged in the SOC of 100% or discharged in the SOC of 0%, deterioration of its life rapidly progresses. The above-described charging/discharging monitoring device controls the charging/discharging with monitoring the state of the battery so that neither a full charge state nor a full discharge state occurs.

More specifically, there is a trade-off between a ratio of the energy capacity of a pre-defined capacity contained in the battery, which is charged and discharged in practical, and the number of chargeable/dischargeable times which is the battery life. For example, in a case that the battery is used in a range of the SOC of 10% to 90%, while 80% of the pre-defined capacity is secured as an effective capacity, there is a possibility that the number of chargeable/dischargeable times is ½ or less compared to that in a case that the battery is used in a range of the SOC of 30% to 70% (that is, the effective capacity is 40% of the pre-defined capacity).

In order to fully use a performance of the secondary battery to be used, it is required to control the charging/discharging at a high accuracy based on a voltage control which is set in consideration of the trade-off between the ratio of the energy capacity of the pre-defined capacity contained in the above-described battery, which is charged and discharged in practical, and the number of chargeable/dischargeable times which is the battery life as described above.

The charging/discharging monitoring device of the present embodiment is provided with: a plurality of monitoring integrated circuits IC1 to ICm; and a signal transmission path which connects between the plurality of monitoring integrated circuits, and each of the above-described monitoring integrated circuits is configured as an integrated circuit device in which a functional block is arranged on a semiconductor substrate, the functional block including: a monitoring circuit MC which monitors and controls the charge state of each cell at the high accuracy as described above; and an input/output circuit (including a data reception circuit DR, a data transmission circuit DT, a clock reception circuit CR, and a clock transmission circuit CT). The above-described signal transmission path is configured of capacitors C1 to C12 and resistors R1 to R12 arranged so as to correspond to respective terminals of the input/output circuits; and electric conductive lines which connect between the resistors and the corresponded capacitors. As described below in detail, this is a configuration by which a detection signal of a charge voltage detected in a monitoring circuit MC and a control signal for controlling the charge state of each cell are accurately communicated.

The respective above-described plurality of monitoring integrated circuits IC1 to ICm are manufactured as semiconductor chips (that is, semiconductor integrated circuit units) separated from each other, and each of the monitoring integrated circuits is embedded and mounted on one circuit wiring board together with the corresponding capacitor and resistor, and the above-described circuit wiring boards are electrically connected to each other via the above-described electric conductive lines. In such a configuration, the monitoring integrated circuits IC1 to ICm are connected in a daisy chain connection (nose-to-tail connection) via the above-described signal transmission path. That is, the monitoring integrated circuit IC1 corresponded to the negative terminal “−” of the battery pack is located at the most downstream part, and the monitoring integrated circuit IC2 to the monitoring integrated circuit ICm are connected in the daisy chain connection such that the monitoring integrated circuit IC2 is connected at an upper-stream part than that, and . . . , the monitoring integrated circuit ICm is connected at an upper-stream part, and the monitoring integrated circuit ICm arranged electrically at the most upstream part is connected to the positive terminal “+” of the battery pack.

The charging/discharging monitoring device is further connected to a microcontroller unit MCU, and an interface circuit IF is provided in the monitoring integrated circuit IC1, so that a signal is transmitted/received to/from the above-described microcontroller unit MCU via a signal transmission path such as an SPI (Serial Peripheral Interface) bus—an optocoupler OPC—an SPI bus although not particularly limited. They are mounted in the battery pack, and configure a battery monitoring system. And, the above-described microcontroller unit MCU is connected to a charging/discharging control circuit (not illustrated) via an external transmission terminal, and the charging/discharging control circuit controls the charging/discharging of the battery in accordance with a monitor result of the charging/discharging monitoring device.

In the embodiment illustrated in FIG. 1, as a representative of the above-described signal transmission path, a set of signal transmission paths through which the transmission and the reception are performed between the monitoring integrated circuit IC1 and the monitoring integrated circuit IC2 is exemplified. The above-described one set of the signal transmission paths exemplified in FIG. 1 is configured of: a first transmission path through which the signal is transmitted toward the upstream side of the daisy chain; a second transmission path through which the signal is transmitted toward the downstream side of the daisy chain; and a third transmission path through which a clock used for such a data transmission is transmitted. Each of the first, the second, and the third transmission paths is configured of paired signal transmission paths of a two-wire system through which a differential data (complementary signal) is transmitted.

The two-wire transmission path which configures the above-described first transmission path provided between the data transmission circuit DT1 of the monitoring integrated circuit IC1 and the data reception circuit DR2 of the monitoring integrated circuit IC2 is configured as follows in order to prevent the influence of the exogenous electromagnetic wave noises and achieve the extension of the transmission distance, and besides, to exclude the influence to/from the communication counterpart in direct current. A positive phase signal of data outputted from an output terminal “TX1” of the data transmission circuit DT1 provided in the monitoring integrated circuit IC1 is communicated to one of the paired signal transmission paths via an output capacitor C9. A negative phase signal of data outputted from an output terminal “/TX1” thereof is communicated to the other of the paired signal transmission paths via an output capacitor C10.

The positive phase signal of the data communicated via one of the above-described paired signal transmission paths which configure the above-described first transmission path is inputted via an input capacitor C3 to an input terminal “RX2” of the data reception circuit DR2 provided in the monitoring integrated circuit 102. The negative phase signal of the data communicated via the other of the paired signal transmission paths which configure the above-described first transmission path is inputted via an input capacitor C4 to an input terminal “/RX2”.

As similarly to the above-described first transmission path, the above-described second transmission path through which the signal is communicated toward the downstream side of the above-described daisy chain is configured of the two-wire transmission path, and a positive phase signal outputted from an output terminal TX2 of the data transmission circuit DT2 provided in the monitoring integrated circuit IC2 is communicated to one of the paired signal transmission paths via an output capacitor C5 and is inputted via an input capacitor C11 to an input terminal RX1 of the data reception circuit DR1 of the monitoring integrated circuit IC1. A negative phase signal outputted from an output terminal /TX2 of the above-described data transmission circuit DT2 is communicated to the other of the paired signal transmission paths via an output capacitor C6, and is inputted via an input capacitor C12 to an input terminal /RX1 of the data reception circuit DR1 of the monitoring integrated circuit IC1.

The above-described third transmission path through which the clock is communicated is configured of the two-wire transmission path as similarly to the above-described the first and the second transmission paths, and a positive phase clock outputted from an output terminal CX1 of the clock transmission circuit CT1 provided in the monitoring integrated circuit IC1 is communicated to one of the paired signal transmission paths via an output capacitor C7, and is inputted via an input capacitor C1 to an input terminal CX2 of the clock reception circuit CR2 of the monitoring integrated circuit IC2. A negative phase clock outputted from an output terminal /CX1 of the above-described clock transmission circuit CT1 is communicated to the other of the paired signal transmission paths via an output capacitor C8, and is inputted via an input capacitor C2 to an input terminal/CX2 of the clock reception circuit CR2 of the monitoring integrated circuit IC2.

Transmission paths which connects between the monitoring integrated circuit IC2 and the monitoring integrated circuit IC3 in FIG. 1 and connects between other monitoring integrated circuits IC4 to ICm not illustrated can be also achieved with the same configuration as those of the above-described first, second, and third transmission paths which connect between the monitoring integrated circuit IC1 and the monitoring integrated circuit IC2 in FIG. 1.

<Configuration of Monitoring Circuit>

FIG. 2 illustrates a block diagram of an embodiment for explaining a monitoring circuit MC mounted on each of the above-described monitoring integrated circuits IC1 to ICm in detail. In FIG. 2, as a representative, the monitoring integrated circuit IC1 corresponded to the block 1 in the battery connection connected in the series configuration is exemplified. In the block 1, 12 battery cells formed of battery cells E1 to E12 are connected in the series configuration. A battery voltage between a negative electrode and a positive electrode of each of the battery cells E1 to E12 is connected to an electrode terminal of the monitoring integrated circuit IC1. The negative electrode of the battery cell E1 is connected to the most-downstream potential of the monitoring integrated circuit IC1 such as a ground potential GND. The positive electrode of the battery cell E12 is connected to the most-upstream potential VCC of the monitoring integrated circuit IC1.

The battery voltage between the positive electrode and the negative electrode of each of the battery cells E1 to E12 including the above-described GND and VCC is alternatively communicated to an analog/digital conversion circuit ADC via a multiplexer MUX, and is converted into a digital signal. A value of the battery voltage of each battery cell which is converted into the digital signal by the analog/digital conversion circuit ADC is taken into registers REG1 to REG12 provided so as to correspond to the resistive battery cells E1 to E12. These registers REG1 to REG12 are also used for storing a control bit which controls ON/OFF of a discharge circuit provided in the corresponded battery cell.

Between the electrode terminals of the monitoring integrated circuit IC1 to which the positive electrode and the negative electrode of the battery cell E1 are connected, a discharge circuit formed of a resistor and a switch MOSFET Q1 is provided. Also between the electrode terminals of the monitoring integrated circuit IC1, which is corresponded to each of the other battery cells E2 to E12, a discharge circuit formed of a resistor and each of switch MOSFETs Q2 to Q12 is provided as similarly to the above description. For example, by turning the switch MOSFET Q1 ON, only the battery cell E1 can be discharged via the resistor and the switch MOSFET Q1 so that the battery voltage is lowered. By setting the control bit, which is provided separately from the digital signal corresponded to the battery voltage value of the above-described register REG1, to be, for example, a logic “1”, the above-described switch MOSFET Q1 can be turned ON so that the above-described discharging operation is activated. By setting it to be logic “0”, the above-described switch MOSFET Q1 can be turned OFF so that the discharging operation is stopped.

A control circuit CONT is formed of a logic circuit so as to execute a predetermined logic, and handles a selective operation of the multiplexer MUX, a control operation of the analog/digital conversion circuit ADC and the registers REG1 to REG12, and a control operation of the above-described discharge circuit corresponded to the control bit of each of the registers REG1 to REG12 under the control of the above-described microcontroller unit MCU. Then, the control circuit CONT communicates, for example, a charge voltage of the battery cell E1 to the analog/digital conversion circuit ADC by the multiplexer MUX. Then, the control circuit CONT selects the register REG1 so that the battery voltage value of the battery cell E1 formed by the analog/digital conversion circuit ADC is stored in the register REG1. In this manner, when the battery voltages of the battery cells E1 to E12 are stored in the registers REG1 to REG12, the signal is serially outputted toward the microcontroller unit MCU via the interface circuit IF in accordance with a control instruction or others from the microcontroller unit MCU. Also, the control circuit CONT rewrites the control bit of the register REG1 in accordance with a control instruction or others from the microcontroller unit MCU, and turns the switch MOSFET Q1 ON if this control bit is the logic “1” so that the battery cell E1 is discharged.

Processes described above are performed by execution of a program loaded in the above-described microcontroller unit MCU. For example, such procedures as [voltage measurement of each battery]→[writing a measurement result into register REGₙ]→[logic processing by control circuit CONT based on register data]→[controlling of operation of multiplexer MUX and operation of analog/digital conversion circuit ADC]→[writing a result into register REGₙ₊₁] are executed, and then, such routine processing as [reading voltage information]→[writing a result into register REGₘ]→[logic processing by control circuit CONT based on register data]→[transmitting a result to interface circuit IF]→[transmitting to microcontroller unit MCU] are executed. When anomaly is detected in the above-described voltage information, the microcontroller unit MCU performs an interruption processing in which [continuously measuring voltage]→[continuing measurement]→[writing into register]→[logic processing by control circuit CONT based on register data], and, when the anomaly is confirmed, the microcontroller unit MCU communicates a signal indicating the anomaly to the charging/discharging control circuit via the external transmission terminal connected to an external connection terminal. Temperature monitoring is performed also by the same routine.

In FIG. 1, pieces of data of the registers REG1 to REG12 in the monitoring integrated circuit IC2 corresponded to the battery voltage values of the resistive battery cells formed by the analog/digital conversion circuit ADC as illustrated in the above-described FIG. 2 are serially communicated toward the microcontroller unit MCU via the data transmission circuit DT2 of the monitoring integrated circuit IC2—the two-wire transmission path—the data reception circuit DR1 of the monitoring integrated circuit IC1. Hereinafter, pieces of data of the registers REG1 to REG12 in each of the monitoring integrated circuits IC3 to ICm are also communicated to the downstream side along the daisy chain as described above. The control bit for controlling the discharge circuit provided so as to correspond to each of the battery cells of the above-described monitoring integrated circuits IC2 to ICm is communicated to the upstream side along the daisy chain from the above-described microcontroller unit MCU in a reverse direction to the above-described direction, and is distributed to the corresponded monitoring integrated circuit.

In FIG. 2, although not particularly limited, the monitoring circuit MC is operated with taking a negative electrode voltage of the above-described battery cell as a reference voltage GND and taking 3 V obtained by lowering (stepping down) a positive electrode voltage of the battery cell E1 such as 4.2 V as an operation voltage. If the handling of the operating current of each circuit provided in the monitoring integrated circuit IC1 by only the battery cell E1 of the 12 battery cells E1 to E12 is inconvenient to equalization of each voltage of the battery cells E1 to E12, the operating voltage such as about 3 V may be formed by lowering the above-described GND and VCC. The operating voltage such as the 3 V and the reference voltage GND are also used as the operating voltage for the above-described data transmission circuit DT1, the data reception circuit DR1, the clock transmission circuit CT1, and the interface circuit IF, which are other circuits for configuring the monitoring integrated circuit IC1.

The monitoring circuit MC of the monitoring integrated circuit IC2 corresponded to the block 2, which is not illustrated, is also configured as similarly to the monitoring circuit MC of the above-described monitoring integrated circuit IC1. As described above, in the case that the block 1 is configured by connecting the 12 lithium-ion secondary batteries having 4.2 V in series, the monitoring integrated circuit which handles a range of the lowest voltage handles a range of 0 V to 50.4 V. The monitoring integrated circuit IC2 corresponded to the block 2 having the second-lowest voltage range monitors a voltage range of 50.4 V to 100.8 V. However, this monitoring integrated circuit IC2 takes 50.4 V as the reference voltage GND, and therefore, the voltage in the inside of the monitoring integrated circuit IC2 is the same as that of the above-described monitoring integrated circuit IC1. Hereinafter, although voltages as absolute values of the voltage ranges corresponding to the block 2 to block m (8) are different from each other, an internal voltage of each of the monitoring integrated circuits IC2 to ICm is the same as that of the above-described monitoring integrated circuit IC1.

In the battery monitoring system of the present embodiment, a measurement result (voltage value, temperature) for each battery cell which is measured under the control of the microcontroller unit MCU is taken in as the digital signal, and is stored in the register. When the SOC of the battery pack is used between X % and Y %, the charging/discharging operation is controlled by the charging/discharging control circuit provided outside the battery pack such that the charging operation is stopped if the charge voltage is increased up to X % and the charging operation is activated if the voltage is decreased down to Y %. Inside the battery pack, the charge voltage of each battery cell is circumstantially controlled by the above-described monitoring integrated circuits IC1 to ICm and the microcontroller unit MCU. For example, when the activation of the charging operation starts, the discharge circuit is operated in other battery cells to be discharged in accordance with the battery cell having the lowest charge voltage among the taken-in charge voltage data of the respective battery cells. And, the charge voltage of each battery cell is monitored even during the charging to reach the target X %, and the discharge circuit is operated as described above for one where the charge voltage is extremely high so as to prevent the overcharge or others.

Since the battery monitoring control operation is performed as described above based on the digital charge voltage data of each battery cell which is taken into the microcontroller unit MCU, if there is an error in this digital charge voltage data, integrity between the control operation instructed by the microcontroller unit MCU and the actual charge voltage of the battery cell is not maintained. In a battery pack mounted on the HEV, the relatively large electromagnetic wave noises in the gasoline engine are received. Since the above-described monitoring integrated circuits IC1 to ICm are connected in the daisy chain, it is not avoided that the electromagnetic wave noises are necessarily superimposed on the signal transmission paths from each other. Even in a battery pack mounted on the EV not having the gasoline engine, the electromagnetic wave noises caused from a gasoline engine vehicle or motorcycle which is running in parallel to the EV are received even during the vehicle stopping or running, and therefore, the same problem arises.

Due to such electromagnetic wave noises, the noises are superimposed on the charge voltage data of each battery cell communicated as the digital signal. If even 1 bit whose logic is “0” in the data formed of a plurality of bits is mistakenly communicated as the logic “1” to the microcontroller unit MCU, the microcontroller unit MCU performs the control operation based on the mistaken data. Therefore, in the data transmission operation with the daisy chain in the battery monitoring system, if there is an error in the signal transmission thereof, a large problem arises.

In the above-described two-wire transmission path adopted in the present embodiment, the capacitor is arranged on each of the output side and the input side so as to isolate in direct current between the output side and the transmission path and between the input side and the transmission path. By such isolation in direct current, a direct-current voltage (bias voltage or others) of an output-side circuit is not influenced by a direct-current voltage from the input side, and a direct-current voltage (bias voltage or others) of an input-side circuit is not influenced by a direct-current voltage from the output side, either. In this manner, even if one device (monitoring integrated circuit IC) is destroyed by a certain cause, this does not directly affect the other device (monitoring integrated circuit IC).

A transmission path between both of the capacitors is arranged between the wiring boards, and there is a possibility that the transmission path is lengthened depending on the arrangement of the battery pack, and therefore, the influence of the exogenous electromagnetic waves cannot be avoided. And, in the transmission path, a noise voltage caused by the exogenous electromagnetic wave noises occurs. However, the transmission path is configured by the two-wire system, and therefore, only a noise voltage in a common mode occurs. Such a noise voltage in the common mode can be cancelled by the input circuit configured of the differential circuit or others. Since the noise voltage in accordance with the exogenous electromagnetic wave noises can be cancelled by the input-side circuit in the two-wire transmission path of the present embodiment, the transmission distance can be also extended with preventing the influence of the above-described exogenous electromagnetic wave noises. In the battery monitoring system of the present embodiment, the charge voltage data of the battery cell at high quality can be communicated to the microcontroller unit MCU with preventing the influence of the exogenous electromagnetic wave noises as described above, and therefore, the accurate charging/discharging control operation in accordance with the actual condition of the battery cell can be performed.

Note that, since each capacitor is arranged on the wiring board on which the corresponded monitoring integrated circuit is mounted, a length of an electric conductive path for connecting between the terminal of the monitoring integrated circuit and the corresponded capacitor is limited to be formed inside the wiring board, and the influence of the exogenous electromagnetic wave noises is restrictive. However, it is desired that the capacitor is arranged in the vicinity of the corresponded terminal so that the length of the electric conductive path between the terminal and the capacitor is shortened as much as possible.

The transmission path for connecting between the above-described both capacitors is in a floating state in direct current, and therefore, there is a possibility that a potential of the exogenous electromagnetic wave noises becomes abnormally high so as to exceed the breakdown voltages of both of the capacitors as viewed from the output-side circuit or the input-side circuit. In the embodiment in the above-described FIG. 1, the resistors R1 to R12 are provided in order to prevent destruction of the breakdown voltages of the capacitors due to the exogenous electromagnetic wave noises. That is, the signal transmission path for connecting between capacitors C1 and C7 is connected to a direct-current middle potential point (VCC, GND) between both of the monitoring integrated circuits IC1 and 102 via the resistors R1 and R7. The similar resistors R2 to R6 and R8 to R12 are provided also to the signal transmission paths for connecting between other respective capacitors C2 to C6 and C8 to C12. Note that the resistors R1 to R12 can be attached so as to be connected and arranged to the transmission paths corresponded to the circuit wiring boards to which the monitoring integrated circuits attached.

As illustrated in the embodiment of FIG. 2, when it is set that the reference potential GND of the monitoring integrated circuit IC1 is 0 V so as to correspond to the negative electrode of the battery cell E1 and set that the reference potential GND of the monitoring integrated circuit IC2 is 50.4 V as described above so as to correspond to the positive electrode of the battery cell E12, roughly speaking, a direct-current voltage corresponding to the above-described 50.4 V is applied to the capacitors C1 and C7 which configure one transmission path, and therefore, a half voltage thereof which is 25.2 V is assigned thereto if capacity values of the capacitors C1 and C7 are equal to each other. However, the transmission path for connecting between the capacitors C1 and C7 is in the floating state in direct current, and therefore, the voltage varies to be a low or high voltage by the exogenous electromagnetic wave noises.

In the present embodiment, for the transmission path for connecting between both of the output-side and input-side capacitors, the bias voltage of GND corresponding to the negative electrode of the battery cell in the block 2 and the bias voltage of VCC corresponding to the positive electrode of the battery cell in the block 1 can be given by the above-described resistances R1 to R6 and R7 to R12. In this manner, the noise voltage caused by the exogenous electromagnetic wave noises varies with centering the above-described GND and VCC, so that an extremely high noise voltage is not adversely applied to one of both of the capacitors.

<Configuration of Data Reception Circuit (Clock Reception Circuit)>

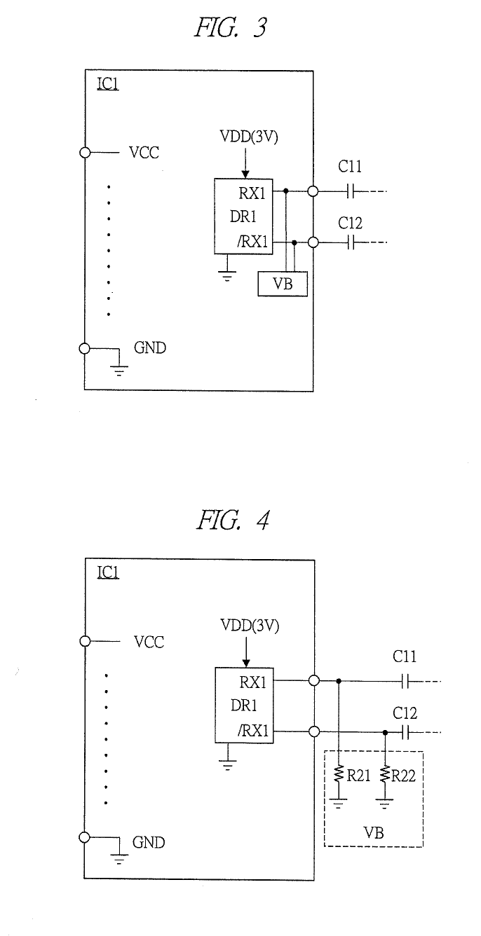

FIG. 3 illustrates a block diagram of an embodiment of the data reception circuit (clock reception circuit) provided in the monitoring integrated circuit according to the present invention. In the present embodiment, the data reception circuit DR1 provided in the above-described monitoring integrated circuit IC1 is exemplified as a representative. A positive phase signal is inputted into an external input terminal of the monitoring integrated circuit IC1 via the input-side capacitor C11. This positive phase signal is supplied to the input terminal RX1 of the data reception circuit DR1. A negative phase signal is inputted into an external input terminal of the monitoring integrated circuit IC1 via the input-side capacitor C12. This negative phase signal is supplied to the input terminal /RX1 of the data reception circuit DR1. A bias circuit VB biases a direct-current voltage formed inside the monitoring integrated circuit IC1 and applied to the above-described paired external input terminals to a potential in an allowable input range of the differential input circuit which configures the data reception circuit with using a resistor for impedance matching which prevents or suppresses occurrence of a reflection noise on the reception signal and using others.

Note that a configuration of the data reception circuit DR1 illustrated in FIG. 3 is also the same as that in the data reception circuit DR2 provided in the above-described monitoring integrated circuit IC2 and others, and besides, is also the same as that in the clock reception circuit CR2.

<Other Configuration of Data Reception Circuit (Clock Reception Circuit)>

FIG. 4 illustrates a block diagram of another embodiment of the data reception circuit (clock reception circuit) provided in the monitoring integrated circuit according to the present invention. Also in the present embodiment, the data reception circuit DR1 provided in the above-described monitoring integrated circuit IC1 is exemplified as a representative. As similarly to the above description, a positive phase signal is inputted into an external input terminal of the monitoring integrated circuit IC1 via the input-side capacitor C11. This positive phase signal is supplied to the input terminal RX1 of the data reception circuit DR1. A negative phase signal is inputted into an external input terminal of the monitoring integrated circuit IC1 via the input-side capacitor C12. This negative phase signal is supplied to the input terminal /RX1 of the data reception circuit DR1. The resistors R21 and R22 provided outside the monitoring integrated circuit IC1 configures the bias circuit VB. This bias circuit VB is formed outside the monitoring integrated circuit IC1 so as to supply a direct-current voltage applied to the above-described paired external input terminals and performs an operation of impedance matching which prevents or suppresses occurrence of the reflection noise on the reception signal.

Note that a configuration of the data reception circuit DR1 illustrated in FIG. 4 is also the same as that in the data reception circuit DR2 provided in the above-described monitoring integrated circuit IC2, and besides, is also the same as that in the clock reception circuit CR2.

<Explanation of Two-Wire Transmission Path>

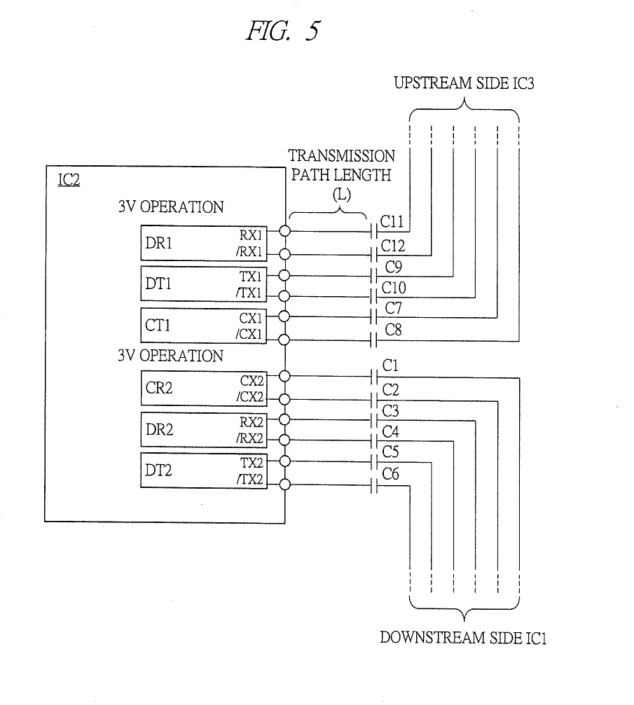

FIG. 5 illustrates an explanatory diagram of the two-wire transmission path connected to the data reception circuit (clock reception circuit) and the data transmission circuit (clock transmission circuit) provided in the monitoring integrated circuit according to the present invention. In the present embodiment, the data reception circuits DR1 and DR2, the data transmission circuits DT1 and DT2, the clock reception circuit CR2, and the clock transmission circuit CT1 provided in the above-described monitoring integrated circuit IC2 are illustrated as a representative.

The transmission paths, for connecting between the external terminals of the monitoring integrated circuit IC2 and the input-side capacitors C1 to C4 provided for the clock reception circuit CR2 and the data reception circuit DR2 and the output-side capacitors C5 and C6 provided for the data transmission circuit DT2 which are illustrated as the representative, function as an antenna for the exogenous electromagnetic wave noises as viewed from the monitoring integrated circuit IC2. Similarly, the transmission paths, for connecting between the external terminals of the monitoring integrated circuit IC2 and the input-side capacitors C11 and C12 provided for the other data reception circuit DR1 and the output-side capacitors C9, C10, C7, and C8 provided for the data transmission circuit DT1 and the clock transmission circuit CT1, similarly function as an antenna for the exogenous electromagnetic wave noises.

In the present embodiment, a transmission path length “L” for connecting between the external terminal of the above-described monitoring integrated circuit IC2 and the input-side or output-side capacitor is set as follows. With respect to the shortest wavelength “λ” of the exogenous electromagnetic wave noises, the L is set such as a relation of “L<λ/4”. That is, by setting the transmission path for connection to/from each of the above-described input-side or output-side capacitors so as to have a length which does not resonate with the noise electromagnetic wave, the exogenous electromagnetic wave noises caused from the daisy chain line for connecting the monitoring integrated circuits to each other can be substantially blocked. In the battery monitoring system, the influence of the exogenous electromagnetic wave noises is more exactly prevented as described above, so that the charge voltage data of the battery cell at the high quality can be communicated to the microcontroller unit MCU, and therefore, the accurate charging/discharging control operation in accordance with the actual condition of the battery cell can be performed.

<Circuit and Signal of Data Transmission Circuit (Clock Transmission Circuit)>

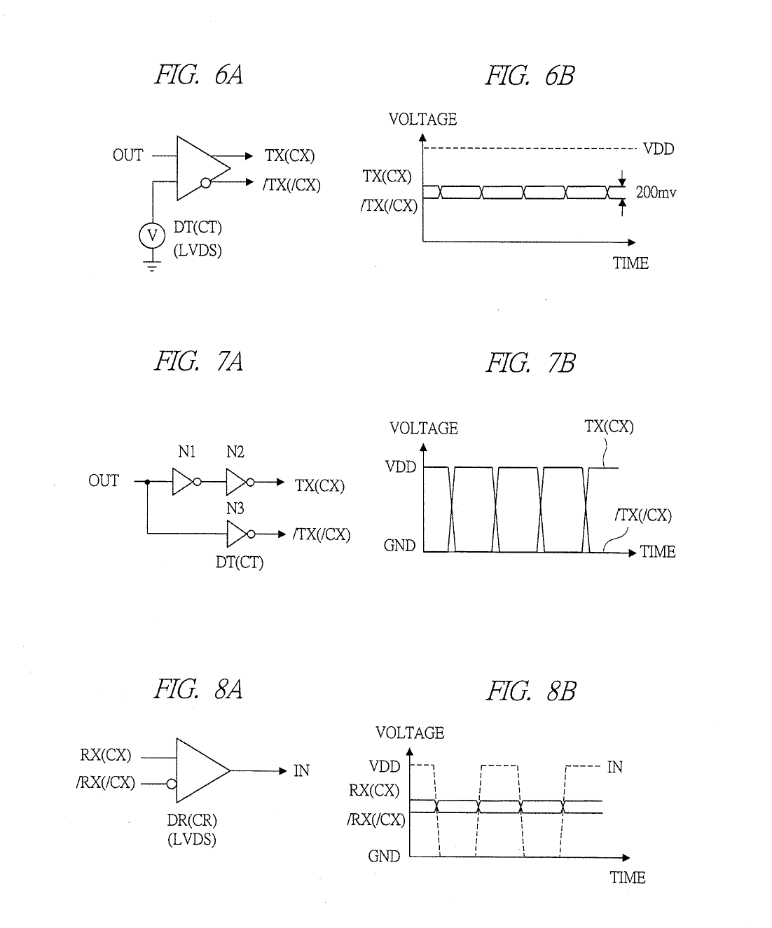

FIGS. 6A and 6B illustrate explanatory diagrams of an embodiment of the data transmission circuit (clock transmission circuit) provided in the monitoring integrated circuit according to the present invention. The data transmission circuit DT (clock transmission circuit CT) of FIG. 6A receives a binary signal “OUT” formed of a high level corresponding to the operating voltage VDD such as 3 V and a low level corresponding to the ground potential GND of the circuit, and outputs a positive phase signal TX (CX) and a negative phase signal /TX (/CX) which are a generally-known LVDS (Low Voltage Differential Signaling). That is, for the data transmission circuit DT (clock transmission circuit CT), a transmission circuit suitable for the LVDS is used. As illustrated in FIG. 6B, the above-described positive phase signal TX (CX) and negative phase signal /TX (/CX) which are complementary signals are a differential signal having a small amplitude such as about 200 mV with centering an almost middle-point voltage of the operating voltage VDD.

<Other Circuit and Signal of Data Transmission Circuit (Clock Transmission Circuit)>

FIGS. 7A and 7B illustrate explanatory diagrams of another embodiment of the data transmission circuit (clock transmission circuit) provided in the monitoring integrated circuit according to the present invention. The data transmission circuit DT (clock transmission circuit CT) of FIG. 7A receives a binary signal “OUT” formed of a high level corresponding to the operating voltage VDD such as 3 V and a low level corresponding to the ground potential GND of the circuit, and outputs a positive phase signal TX (CX) with no change via inverter circuits N1 and N2. The above-described binary signal OUT is inverted via an inverter circuit N3, and is outputted as a negative phase signal /TX (/CX). Each of the above-described inverter circuits N2 and N3 is configured of a MOSFET having a relatively large size so as to obtain a desired driving current. The inverter circuit N1 is configured of a MOSFET having a small size because it performs only a phase inversion operation. As illustrated in FIG. 7B, the above-described positive phase signal TX (CX) and negative phase signal /TX (/CX) which are complementary signals are a differential signal having such a CMOS level amplitude as taking a high level corresponding to the operating voltage VDD and a low level corresponding to the ground potential GND of the circuit.

<Circuit and Signal of Data Reception Circuit (Clock Reception Circuit)>

FIGS. 8A and 8B illustrate explanatory diagrams of an embodiment of the data reception circuit (clock reception circuit) provided in the monitoring integrated circuit according to the present invention. The data reception circuit DR (clock reception circuit CR) of FIG. 8A receives the differential signals RX (CX) and /RX (/CX) having the small amplitude such as about 200 mV transmitted from the above-described data transmission circuit DT (clock transmission circuit CT) of FIGS. 6A and 6B, and forms a binary signal “IN” formed of the high level corresponding to the operating voltage VDD such as 3 V and the low level corresponding to the ground potential GND of the circuit. That is, the data reception circuit DR (clock reception circuit CR) receives the LVDS signal, and converts it into the CMOS level. As illustrated in FIG. 8B, the above-described positive phase signal RX (CX) and negative phase signal /RX (/CX) which are the complementary signals are inputted as the differential signal having the small amplitude such as about 200 mV with centering the almost middle point voltage of the operating voltage VDD as illustrated with a solid line, and the output signal IN of the reception circuit is the binary signal formed of the high level corresponding to the operating voltage VDD and the low level corresponding to the ground potential GND of the circuit as illustrated with a dotted line.

In the differential signal having the small amplitude as illustrated in FIG. 8B, the noise voltage caused by the electromagnetic wave noises as described above is contained. However, in the differential circuit, a difference between the above-described two voltages is taken in, and therefore, the noise voltage can be canceled. Also in the differential signal having the CMOS level amplitude illustrated in the above-described FIG. 7B, the noise voltage can be similarly cancelled by taking the difference in as the input.

<Other Configuration of Battery Pack>

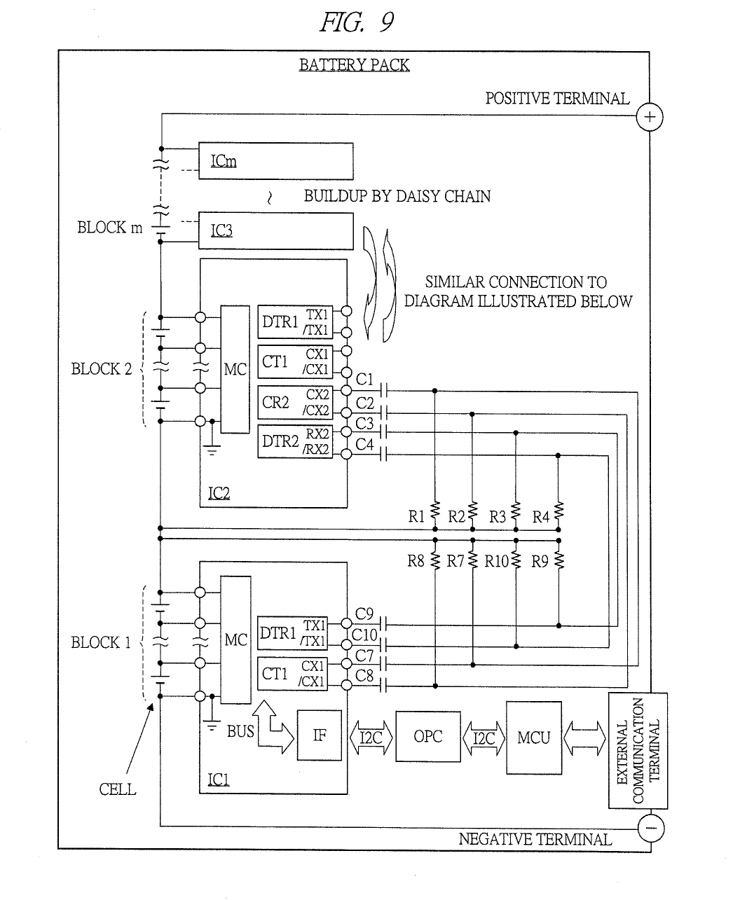

FIG. 9 illustrates a schematic block diagram of another embodiment of the battery pack to which the charging/discharging monitoring device of the present invention is applied. In the present embodiment, the data transmission circuit DT and the data reception circuit DR of the above-described FIG. 1 are configured as one data transmission/reception circuit DTR. In this manner, the paired two-wire transmission paths can be eliminated. For example, by provision of the function of the data reception circuit DR1 to the data transmission circuit DT1 of FIG. 1 or by connection between the output terminal of the data transmission circuit DT1 and the input terminal of the data reception circuit DR1, the data transmission/reception circuit DTR1 can be configured in the monitoring integrated circuit IC1 of FIG. 9, so that the data transmission circuit DT2 and data reception circuit DR1 of the above-described FIG. 1 and the two-wire transmission path for connecting between them can be eliminated. This configuration is also the same as those of other monitoring integrated circuits IC2 to ICm, and the daisy chain is configured of two-paired two-wire transmission paths for the data and clock.

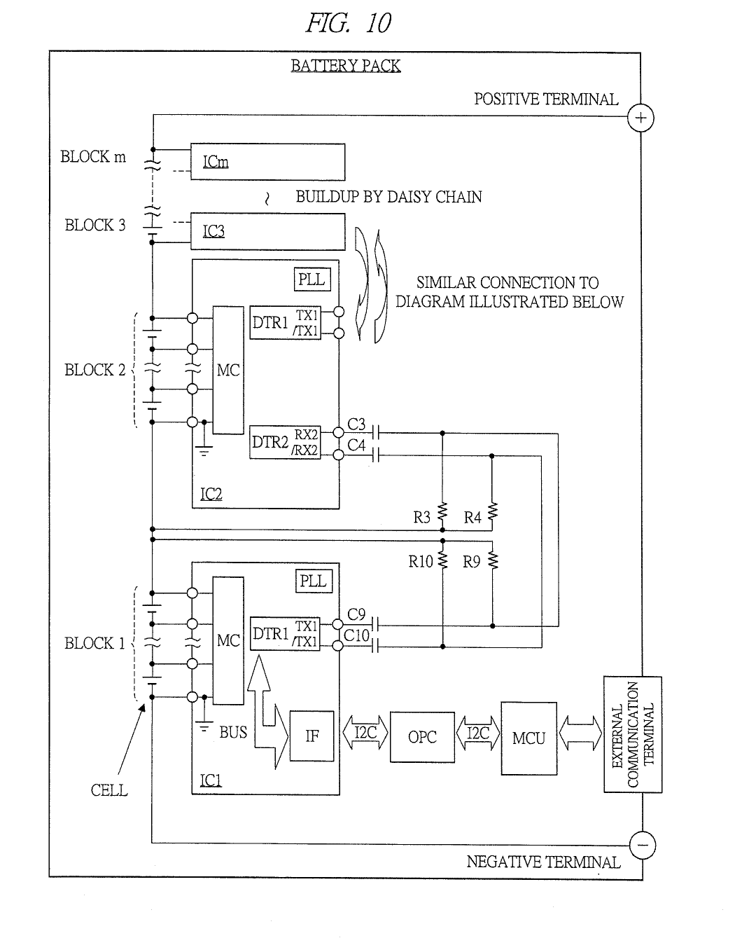

FIG. 10 illustrates a schematic block diagram of still another embodiment of the battery pack to which the charging/discharging monitoring device of the present invention is applied. In the present embodiment, the transmission circuit and reception circuit for the clock and the paired two-wire transmission paths for connecting between them with the daisy chain are also eliminated from the configuration of the embodiment illustrated in the above-described FIG. 9. In the data transmission/reception circuit DTR of the present embodiment, the clock is contained in the data to be transmitted. Therefore, in the monitoring integrated circuits IC1 to ICm, a synchronous-clock reproduction circuit PLL is provided. The synchronous-clock reproduction circuit PLL produces a clock synchronized with a transmitted clock prior to the data transmission, which is used for taking-in the transmitted data subsequent thereto. In order to stabilize the clock reproduction, the PLL (Phase Locked Loop) operation may be synchronized with containing the clock in the data. In the present embodiment, the daisy chain is configured by the paired two-wire transmission paths served for both of the data and the clock.

In the embodiment of the above-described FIGS. 9 and 10, as a bus configuration for connecting between the above-described monitoring integrated circuit IC1 and the microcontroller unit MCU, I2C (Inter-Integrated Circuit) which has small transmission overhead and is considered to be suitable for low interference environment is used as similarly to the SPI bus illustrated in the above-described FIG. 1 although not particularly limited.

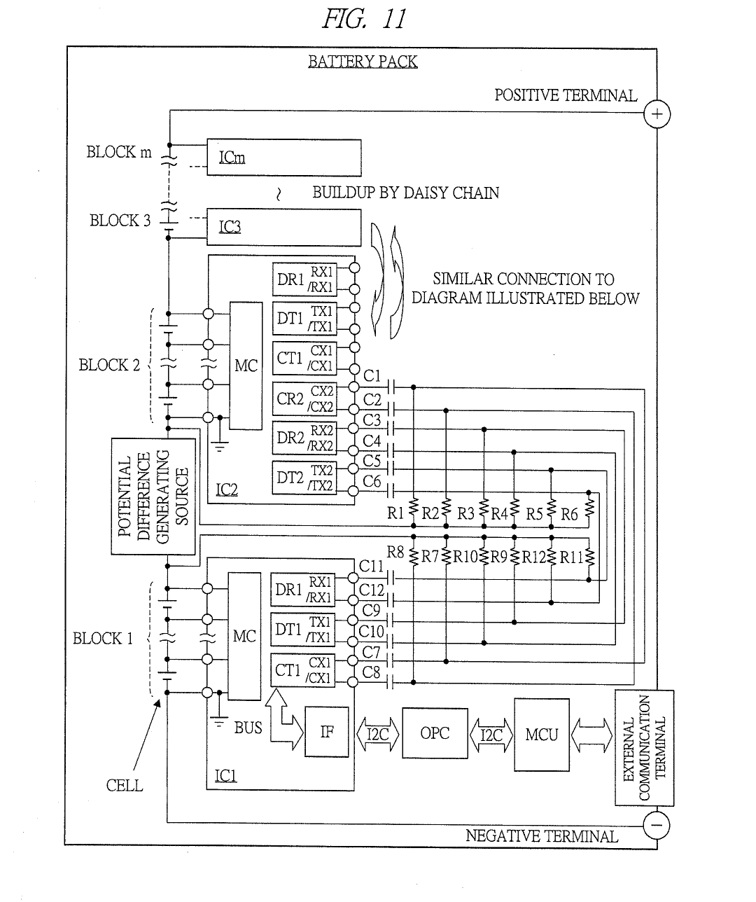

FIG. 11 illustrates a schematic block diagram of still another embodiment of the battery pack to which the charging/discharging monitoring device of the present invention is applied. In the present embodiment, a potential-difference generation source is provided between arbitrary blocks. FIG. 11 illustrates an example in which the potential-difference generation source is provided between the block 1 and the block 2. This potential-difference generation source is, for example, voltage drop caused by a parasitic resistance of a wiring for connecting between the blocks. In consideration of weight distribution or safety of a vehicle, it is required to mount the battery cell blocks at positions which are physically apart from each other in some cases. In such a case, the potential difference is generated between the VCC in the block 1 and the GND in the block 2 by the parasitic resistance of a cable for connecting between the blocks. Even if such a potential difference is generated, the daisy chain of the present embodiment is not influenced by the direct-current voltage difference between the monitoring integrated circuit IC1 and the monitoring integrated circuit IC2 as described above, and therefore, the daisy chain can be set up without adjusting any transmission level or others.

If the problem on the breakdown voltages of the input-side and output-side capacitors which configure the above-described daisy chain can be solved, it is not required to set up the daisy chain in accordance with the buildup of the block 1 to the block m as illustrated in the above-described FIG. 1. In accordance with an actual configuration of the blocks which configure the battery pack, the daisy chain can be set up by connection between arbitrary blocks. For example, when the block 1 and block m are connected to each other, the direct-current voltage as much as about 400 V is applied between the input-side capacitor and the output-side capacitor in the above-described example. However, a capacitor whose breakdown voltage is high so as to support this may be adopted. In the battery monitoring system according to the present invention, a flexible daisy chain in accordance with the mounting configuration of the battery pack can be set up.

<Effect of First Embodiment>

According to the present embodiment described above, in the battery pack including the charging/discharging monitoring device including: the monitoring integrated circuits ICs; the wiring boards on which the respective monitoring integrated circuits ICs are mounted; and signal transmission paths for connecting between the wiring boards, a part between the terminal of the upstream-side monitoring integrated circuit IC and the terminal of the downstream-side monitoring integrated circuit IC in the daisy chain connection is configured by the two-wire transmission path for connecting them via each corresponded capacitor C, and a wire length of a wiring part for connecting between each capacitor C and the terminal of the corresponded monitoring integrated circuit IC on the wiring board is configured of the length which does not resonate with the noise electromagnetic wave in the electromagnetic wave noise environment under which the wiring board is arranged, so that, typically, the influence of the exogenous electromagnetic wave noises can be prevented, and the transmission distance can be extended, and besides, the influence to/from the transmission counterpart in direct current can be excluded.

More particularly, for the two-wire transmission paths, further effect can be expected by arranging the two-wire transmission paths so as to be equivalent to each other with respect to the potential variation caused by the electromagnetic wave noises, or by selecting the battery cell voltage so that the direct-current voltages applied to each of them are almost equal to each other. Also, further effect can be expected because of the impedance matching operation by connecting the bias circuit VB suitable for the reception circuit provided in the monitoring integrated circuit IC to the input terminal of this monitoring integrated circuit IC.

Further, by configuring the data reception circuit DR and the data transmission circuit DT as one data transmission/reception circuit DTR, by commonly using each terminal as an input/output terminal, and by also commonly using the two-wire transmission path, the two-way transmission/reception transmission can be achieved by one circuit, the paired input/output terminal, and the set of two-wire transmission path.

### Second Embodiment

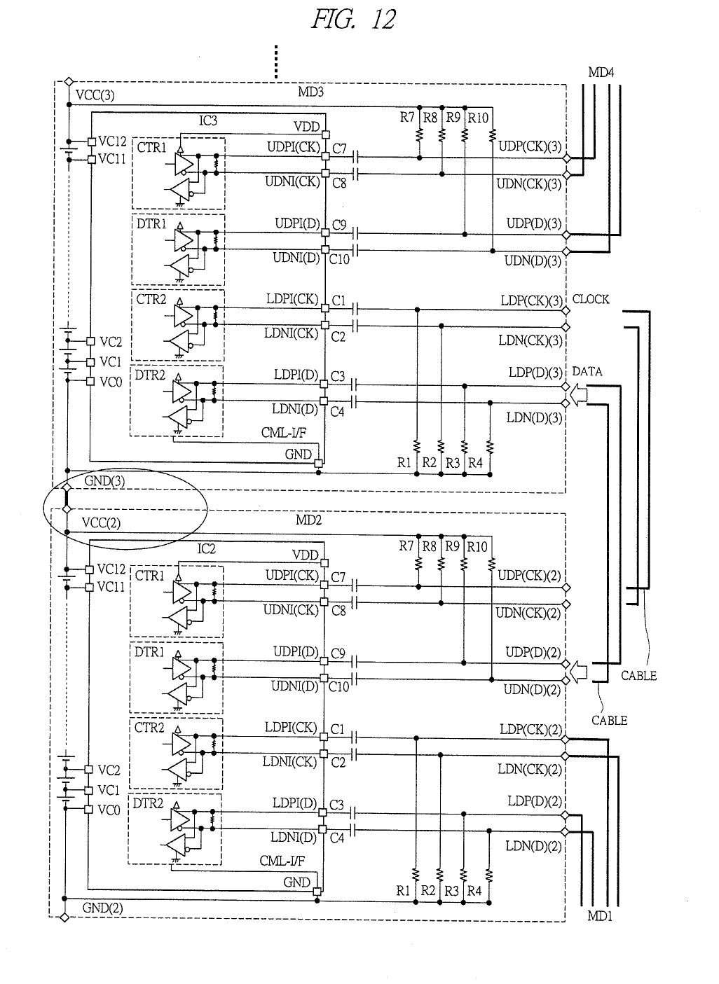

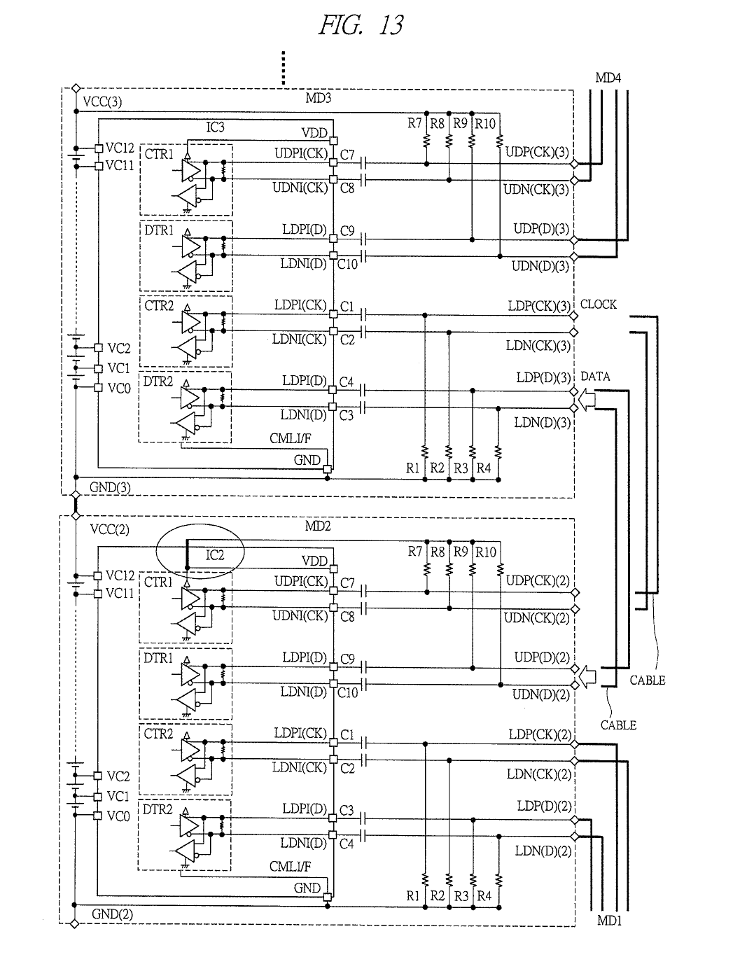

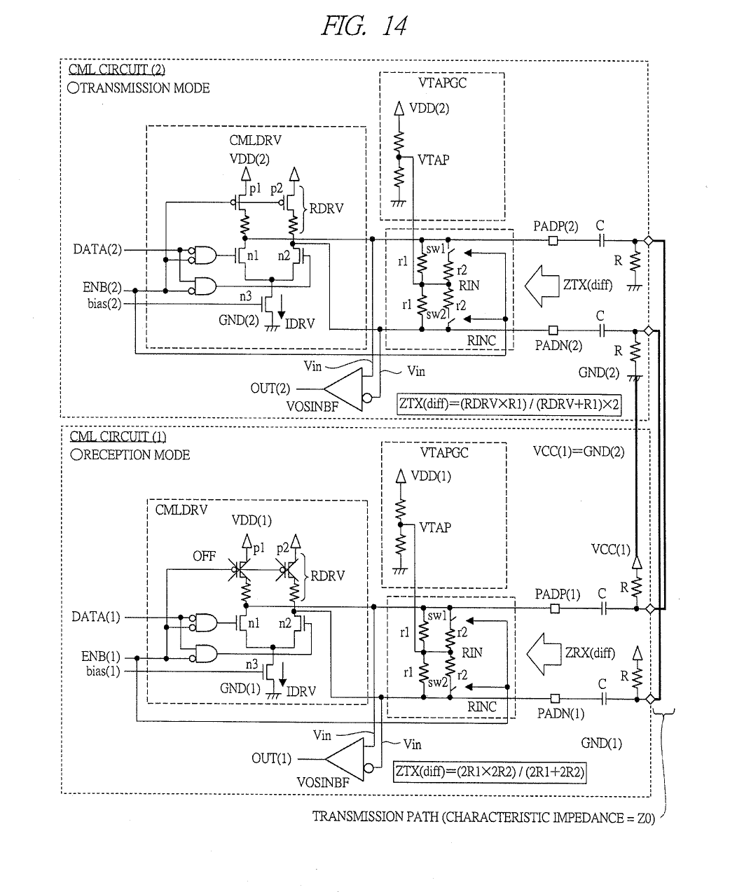

A second embodiment to which the charging/discharging monitoring device of the present invention is applied will be explained with reference to FIGS. 12 to 26. The present embodiment is a more preferable embodiment with the above-described first embodiment as a basic configuration, and will be explained sequentially based on each drawing.

<Configuration of Resistive Connection in 2-Series Capacitive Coupling>

FIG. 12 illustrates a schematic block diagram of a configuration of a resistive connection in 2-series capacitive coupling of a more preferable embodiment of the battery pack to which the charging/discharging monitoring device of the present invention is applied. FIG. 12 illustrates an example of a secondary battery module MD2 and a secondary battery module MD3 (secondary battery modules MD4 to MDm are also the same). Also, the data transmission circuit DT and the data reception circuit DR are configured as one data transmission/reception circuit DTR, and besides, the clock transmission circuit CT and the clock reception circuit CR are configured as one clock transmission/reception circuit CTR. The present embodiment has a feature of the configuration of the resistive connection in the 2-series capacitive coupling. That is, the present embodiment has two problems to be solved that (1) it is desired to communicate between secondary battery modules having a potential difference of about 60 V, and (2) it is desired not to apply an overvoltage (surge) to a device (monitoring integrated circuit IC) at a moment of connection of a cable for connecting between the secondary battery modules.

For the above-described item (1) of the problems, the problem of the potential difference can be cleared by using a capacitive coupling system. This capacitive coupling is a publicly-known technique, and besides, a method having two capacities in 2 series connection (method in which two capacitances are connected in series) is a publicly-known technique as well, and therefore, detailed description here is omitted. Also, for the above-described item (2) thereof, in order to prevent the application of the overvoltage (surge) to the device when the cable is inserted and removed therefrom, (2-1) capacities (C) are connected 2 series, (2-2) a line (GND to VCC) for connecting between the secondary battery modules is provided prior to the connection of the cable, (2-3) in the downstream-side secondary battery module, the resistors R7 to R10 are connected to the VCC (the highest potential inside the secondary battery module), (2-4) in the upstream-side secondary battery module, the resistors R1 to R4 are connected to the GND (the lowest potential inside the secondary battery module), or (2-5) the movement of the charge is not caused at the moment that the cable is inserted and removed therefrom.

More specifically, based on FIG. 12, an entire configuration of the daisy chain connection with the secondary battery measurement system will be explained. The secondary battery cells are connected in series (for example, 12 cells), and each battery and the monitoring integrated circuit IC (IC2 and IC3) for the battery measurement are connected to each other. A block is referred to as a secondary battery module MD (MD2 or MD3), the block in which the secondary battery, the monitoring integrated circuit IC, capacitors C (C1 to C4 and C7 to C10), resistors R (R1 to R4 and R7 to R10), and others are connected. These secondary battery modules MD themselves can be built up (connected in series) onto each other.

The monitoring integrated circuit IC measures an inter-terminal voltage among the terminals VC0 to VC12, and stores its value in a register inside the monitoring integrated circuit IC. It has a function to communicate information of the measured value stored in the register inside the monitoring integrated circuit IC to other monitoring integrated circuit IC via an inter-system transmission mechanism (daisy chain).

The secondary battery module MD is provided with downstream-side connection transmission terminals LDP/LDN (LDP(D)/LDN(D), LDP(CK)/LDN(CK) and upstream-side connection transmission terminals UDP/UDN (UDP(D)/UDN(D), UDP(CK)/UDN(CK)). The downstream-side connection transmission terminal LDP/LDN and the upstream-side transmission terminal UDP/UDN are connected via coupling capacitors C to transmission terminals of the monitoring integrated circuit IC, which are LDPI/LDNI (LDPI(D)/LDNI(D), LDPI(CK)/LDNI(CK))) and UDPI/UDNI (UDPI(D)/UDNI(D), UDPI(CK)/UDNI(CK))). Note that, in the above description, (D) indicates the data, and (CK) indicates the clock.

The downstream-side connection transmission terminals LDP/LDN are connected via the resistors R to the GND terminal which is at the lowest potential of the plurality of battery cells connected in series inside the secondary battery module MD. The upstream-side connection transmission terminals UDP/UDN are connected via the resistors R to the VCC terminal which is at the highest potential of the plurality of battery cells connected in series inside the secondary battery module MD (the VCC terminal is at a potential for the 12 cells, such as about 60 V).

Note that, in the monitoring integrated circuit IC, the LDPI(D) corresponds to the terminal of the positive phase signal of the data, the LDNI (D) corresponds to the terminal of the negative phase signal of the data, the LDPI(CK) corresponds to the terminal of the positive phase signal of the clock, and the LDNI(CK) corresponds to the terminal of the negative phase signal of the clock. Similarly, the UDPI(D) corresponds to the terminal of the positive phase signal of the data, the UDNI(D) corresponds to the terminal of the negative phase signal of the data, the UDPI (CK) corresponds to the terminal of the positive phase signal of the clock, and the UDNI(CK) corresponds to the terminal of the negative phase signal of the clock. Note that, in the correspondence to those of the first embodiment, the LDPI(D) and the LDNI(D) correspond to the RX2 and the /RX2, the LDPI(CK) and the LDNI(CK) correspond to the CX2 and the /CX2, the UDPI(CK) and the UDNI(CK) correspond to the TX1 and the /TX1, and the UDPI(CK) and the UDNI(CK) correspond to the CX1 and the /CX1, respectively.

While the monitoring integrated circuit IC (n) and the monitoring integrated circuit IC (n+1) have different reference voltage levels from each other, only a difference in a signal amplitude therebetween is communicated to each other via the coupling capacitor C. In the secondary battery module MD, the case that it is inserted and removed is considerable. In the insertion or removal of the secondary battery module MD, if power source terminals (such as VCC(2) and GND(3)) are connected first, the resistors Rare at the same potential when the signal terminals (UDP (2) and LDP (3), and UDN(2) and LDN(3)) are connected to each other, and therefore, a transient current does not flow, and the high voltage of the secondary battery module MD3 side is not applied to the monitoring integrated circuit IC2.

A case that a signal transmission in a long distance (several meters or others) is performed between the secondary battery modules MD is assumed. In an application for an electric vehicle or others, a case that large noises are added is assumed. Accordingly, the signal transmission between the secondary battery modules MD is performed as a differential transmission with using a differential circuit configured of a CML (Current Mode Logic) or others so as to have the noise resistance.

As described above, according to the configuration of the resistive connection in the 2-series capacitive coupling of the present embodiment, with the capacitive coupling and devising the connection destinations of the resistors, the resistors R1 to R4 connected to the terminals to be paired in the upstream-side secondary battery module MD(n) of the daisy chain connection with the cables are connected to the lowest potential GND inside this secondary battery module, the resistors R7 to R10 connected to the terminals to be paired in the downstream-side secondary battery module MD(n−1) of the daisy chain connection are connected to the highest potential VCC inside this secondary battery module, and these GND and VCC are connected at an earlier stage of the daisy chain connection, and then, the capacitors C1 to C4 connected to the upstream-side secondary battery module MD(n) and the capacitors C7 to C10 connected to the downstream-side secondary battery module MD(n−1) are connected to each other in series in the daisy chain connection, so that (1) the transmission can be performed between the secondary battery modules MD having the potential difference of about 60 V, and (2) the application of the overvoltage to the devices of the monitoring integrated circuit IC caused at the moment of connecting the cables for connecting between the secondary battery modules MD can be prevented.

<Other Configuration of Resistive Connection in 2-Series Capacitive Coupling>

FIG. 13 illustrates a schematic block diagram of other configuration of the resistive connection in the 2-series capacitive coupling of an embodiment of the battery pack to which the charging/discharging monitoring device of the present invention is applied. FIG. 13 illustrates an example of the secondary battery module MD2 and the secondary battery module MD3. The present embodiment has a feature of a configuration in which the destinations of the resistors are at a potential between the GND(2) to the VCC(2) as other example relative to FIG. 12. That is, as long as the surge applied to the devices in the cable connection is suppressed at a level at which the devices are not broken, the connection destinations of the resistors R7 to R10 of the downstream-side secondary battery module MD2 are not limited to the VCC(2) (for example, the VCC(2)=the GND(2)+60 V, or others), and can be a VDD (for example, the VDD=the GND(2)+3.3 V, or others).

As described above, according to the other configuration of the resistive connection in the 2-series capacitive coupling of the present embodiment, the resistors R1 to R4 connected to the terminals to be paired in the upstream-side secondary battery module MD(n) of the daisy chain connection with the cables are connected to the lowest potential GND inside this secondary battery module, and the resistors R7 to R10 connected to the terminals to be paired in the downstream-side secondary battery module MD(n−1) of the daisy chain connection are connected to the potential VDD within a range between the highest potential VCC and the lowest potential GND inside this secondary battery module, so that (1) the transmission can be performed between the secondary battery modules MD having the potential difference of about 60 V as similarly to the configuration of FIG. 12.

<Configuration in Two-Way Transmission with CML Circuit>

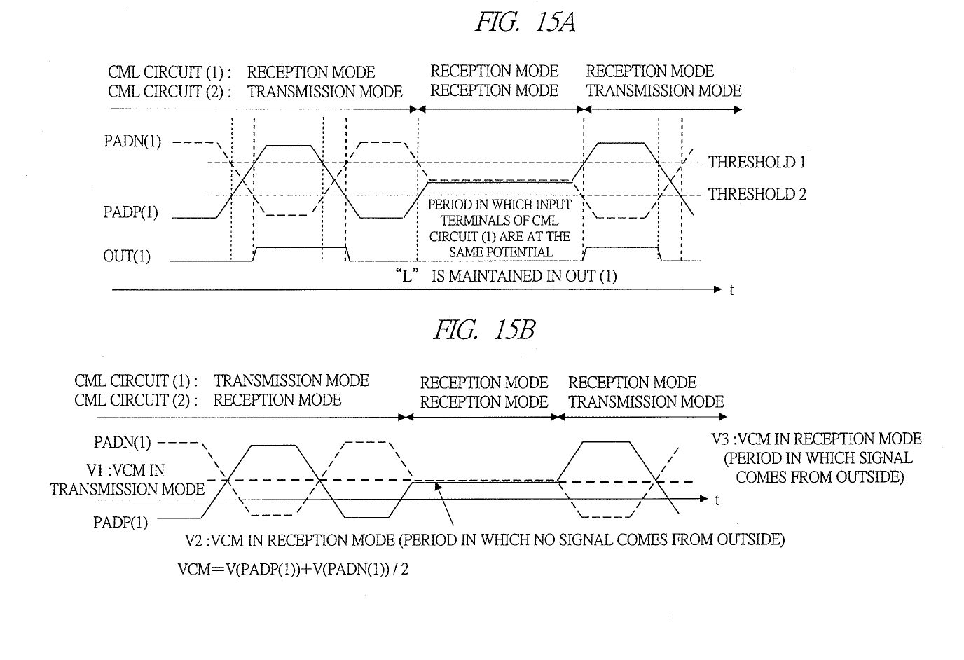

FIGS. 14 and 15 illustrate a circuit diagram and a signal waveform diagram of the configuration in the two-way transmission with the CML circuit in a more preferable embodiment of the battery pack to which the charging/discharging monitoring device of the present invention is applied. FIG. 14 illustrates an example of a transmission/reception circuit of the secondary battery module MD1 and a transmission/reception circuit of the secondary battery module MD2. The present embodiment has a feature of a circuit and a signal in the two-way transmission with the CML circuit. That is, there are three problems to be solved in that (1) it is desired that the two-way transmission is performed in the capacitive coupling system, (2) it is desired that the transmission and the reception can be switched to each other without time lag, and (3) it is desired that signal reflection on an interface between transmission systems (board wiring or cable wiring for connecting between the secondary battery modules) is suppressed.

Accordingly, for the above-described item (1), it is prevented that the output OUT is uncertain by using input circuits with offset (input buffers with offset) even if both buffers are in the reception mode. Also, for the above-described item (2), the transmission and the reception can be switched without the time lag in the capacitive coupling system by equalizing the VCM (amplitude center potential) and the VTAP (resistive division potential obtained by determining the amplitude center in the reception mode). Further, for the above-described item (3), the signal reflection on the interfaces between the transmission systems can be suppressed by controlling a transmission-end resistance (RDRV) and a reception-end resistance (R1, R2) so that a relation of “ZTX(diff)=ZRX(diff)=2×Z0” is established in an assumption of a circuit impedance in the transmission: ZTX(diff), a circuit impedance in the reception: ZRX(diff), and a characteristic impedance of the transmission system: Z0, which results in enabling the high-speed transmission.

More specifically, based on FIGS. 14 and 15, a CML circuit interface to which the two-way transmission function is provided will be explained. FIG. 14 illustrates a case that a CML circuit (1) is in the reception mode and a CML circuit (2) is in the transmission mode. In FIG. 14, “VDD” indicates the power source, “DATA” indicates the data input terminal, “ENB” indicates an output enable terminal (L=transmission mode, H=reception mode), “bias” indicates a bias potential by which a constant current is carried through an nMOS transistor “n3”, “OUT” indicates a data output, and “PADP” and “PADN” indicate input/output pads, respectively.

Also, in circuit components, the transmission-end resistance (RDRV) is configured of pMOS transistors “p1” and “p2” and resistors in a CML transmission driver “CMLDRV”, and is turned on in the transmission mode and off in the reception mode. This CML transmission driver CMLDRV is configured so that pMOS transistor p1 and p2 sides at one end of the transmission-end resistance RDRV are connected to the VDD, so that resistance sides at the other end of the transmission-end resistance RDRV are connected to one ends of nMOS transistors “n1” and “n2” for switches, so that the other ends of these nMOS transistors n1 and n2 are connected to one end of an nMOS transistor “n3” which is a constant current source, and so that the other end of this nMOS transistor n3 is grounded. Further, the data “DATA” is inputted via a gate circuit to a control terminal of the nMOS transistors n1 and n2 for switches.

The reception-end resistance (RIN) is formed of two resistors “r1” and two resistors “r2”, and the resistors r1 are always turned ON, and the resistors r2 are turned OFF in the transmission mode and ON in the reception mode. The reception-end resistance control switches (sw1 and sw2) control ON/OFF of the resistors r2. These two resistors r1 are connected to each other in series and connected between the input/output pads PADP/PADN, and besides, these two resistors r2 connected in series are connected between the input/output pads PADP/PADN via the respective switches sw1 and sw2, so that a reception-end resistance circuit “RINC” is configured. Each connection node of the resistors r1 and the resistors r2 of this reception-end resistance circuit RINC is connected to the amplitude center potential VTAP.

An amplitude-center-potential generating circuit “VTAPGC” which generates the amplitude center potential VTAP is a circuit which generates the amplitude center potential VTAP at the connection node of two resistors connected between the VDD and the GND to set a differential amplitude center. An input buffer with offset “VOSINBF” is an input circuit which performs a response when a potential difference is generated between the input/output pads PADP/PADN.

Also, in the transistor control, in a case that the output data is expressed as “PADP=L” in the transmission mode, relations of “n1=ON”, “n2=OFF”, “p1/p2=ON”, and “sw1/sw2=OFF” are established. On the other hand, in a case that the output data is expressed as “PADP=H” in the transmission mode, relations of “n1=OFF”, “n2=ON”, “p1/p2=ON”, and “sw1/sw2=OFF” are established. Further, in the reception mode, relations of “n1=OFF”, “n2=OFF”, “p1/p2=OFF”, and “sw1/sw2=ON” are established.

In this CML circuit, a CML transmission driver “CMLDRV” is a circuit provided with the nMOS transistors (n1, n2) for switches, the constant current source (nMOS transistor n3), and the transmission-end resistance (RDRV=pMOS transistors p1 and p2 and resistors). Note that neither the constant current source nor the transmission-end resistances is limited to circuits of FIG. 14. Also, although the CML transmission driver driven by the nMOS is used in this example, a CML transmission driver driven by a pMOS may be used.

An ENB terminal whose output can be a high impedance is provided to the CML transmission driver “CMLDRV”. The transmission mode and the reception mode are switched by this ENB terminal. The transmission mode is set when the ENB terminal is at an L level, and a constant current (IDRV) is carried from a PADP (positive phase side terminal) to the GND when the DATA terminal is at an L level. Note that a constant current (IDRV) is carried from a PADN (negative phase side terminal) to the GND when the DATA terminal is at an H level. When the ENB terminal is at an L level, the transmission-end resistance RDRV is turned ON, and the switches sw1 and sw2 configuring the reception-end resistance RIN are turned OFF.

When the ENB terminal is at an H level, the reception mode is set. When the ENB terminal is at an H level, the nMOS transistors n1 and n2 and the transmission-end resistance RDRV are turned OFF. When the ENB terminal is at an H level, the switches sw1 and sw2 configuring the reception-end resistance RIN are turned ON.

Inside the circuit, as the amplitude center potential of the level inputted into the input circuit, the potential (VTAP) is generated by the amplitude-center-potential generating circuit VTAPGC so as to be in a range of a voltage having good sensitivity for the input buffer. By providing the hysteresis characteristic (Schmitt trigger) to the input buffer with offset VOSINBF, a false data is not outputted to the data output (OUT) even when both of two opposing CML interfaces are turned in the reception mode.

For example, as illustrated in FIG. 15A, in a case that the CML circuit (1) shifts as “reception mode→reception mode→reception mode” and that the CML circuit (2) shifts as “transmission mode→reception mode→transmission mode”, when the CML circuit (1) is in the reception mode and the CML circuit (2) is in the reception mode, that is, in a period in which the input terminals of the CML circuit (1) are at the same potential, the data output OUT (1) of this CML circuit (1) is maintained at “L”. In this manner, by the input buffer VOSINBF with offset having two threshold values, even if the input terminals PADN (1) and PADP (1) are at the same potential because the inputs are at the same potential, the uncertain state is not caused in the data output OUT (1).

Also, as illustrated in FIG. 15B, in a case that the CML circuit (1) shifts as “transmission mode→reception mode→reception mode” and that the CML circuit (2) shifts as “reception mode→reception mode→transmission mode”, the amplitude center voltage VCM has a relation of “VCM=V(PADP (1))+V(PADN (1))/2”. The V1 which is the VCM in the transmission mode is determined by the current IDRV and the transmission-end resistance RDRV and the reception-end resistance RIN in the transmission circuit and the reception-end resistance RIN in the reception circuit. The potential of the V2 which is the VCM in the reception mode (when no signal comes from outside) is determined by the amplitude center potential VTAP of the reception circuit. The potential of the V3 which is the VCM in the reception mode (when a signal comes from outside) is determined by the amplitude center potential VTAP of the reception circuit. Accordingly, by designing a relation of “V1=V2 (=V3)”, that is, by designing the VTAP so as to be matched with the VCM in the transmission, it is not required to wait for time until reaching a balance point of the capacitor C for the capacitive coupling (until a charge amount stored in the capacitor C is fixed) even when the transmission and the reception are switched, so that the transmission and the reception can be switched without the time lag.

Subsequently, based on FIG. 14, the impedance as viewed from the outside of the CML circuit will be explained. In order to prevent signal reflection caused by an impedance mismatch between the CML transmission/reception circuit and the transmission system connected to the CML transmission/reception circuit, it is set that the impedance inside the CML transmission/reception circuit is matched with that of the transmission system. For example, when the impedance of the transmission system is 100Ω, if relations of “RDRV=100Ω, R1=100Ω, and R2=100Ω” are set, a differential impedance as viewed from the outside is 100Ω in both of the transmission mode and the reception mode. By preparing two sets of the reception-end resistors so that a resistance value is changed depending on the reception mode and the transmission mode (ON/OFF of the sw1 and sw2 is controlled), the impedance as viewed from the outside of the circuit can be maintained constant in both of the transmission mode and the reception mode. This leads to reduction of the signal reflection accompanied with the impedance mismatch with the transmission system, and contributes to high speed of a data transmission/reception rate (a simple TTL (Transistor-Transistor-Logic) interface having a high impedance input in an input mode or others has difficulty in the high speed because of the signal reflection).

As described above, according to the configuration in the two-way transmission with the CML circuit of the present embodiment, the transmission/reception circuit is formed of the CML circuit, and includes: the input buffer with offset VOSINBF which receives the differential data in the reception mode; the amplitude-center-potential generating circuit VTAPGC which generates the resistive division potential for determining the amplitude center in the reception mode; the reception-end resistance circuit RINC having the reception-end resistance RIN with the resistive division potential as the reference; and the CML transmission driver CMLDRV having the transmission-end resistance RDRV which transmits the differential data in the transmission mode so that the amplitude center potential and the resistive division potential in this differential data are equal to each other, and the transmission-end resistance RDRV and the reception-end resistance RIN are controlled so that the relation of “ZTX(diff)=ZRX(diff)=2×Z0”, so that (1) the two-way transmission can be performed in the capacitive coupling system, (2) the transmission and the reception can be switched without the time lag, and (3) the signal reflection on the interface between the transmission systems can be suppressed. That is, by providing the configuration and control of the embedded resistors and the offset function to the input buffer, the CML differential and two-way transmission can be smoothly performed in the capacitive coupling system.

<Configuration with Embedded CML Circuit and TTL Circuit>

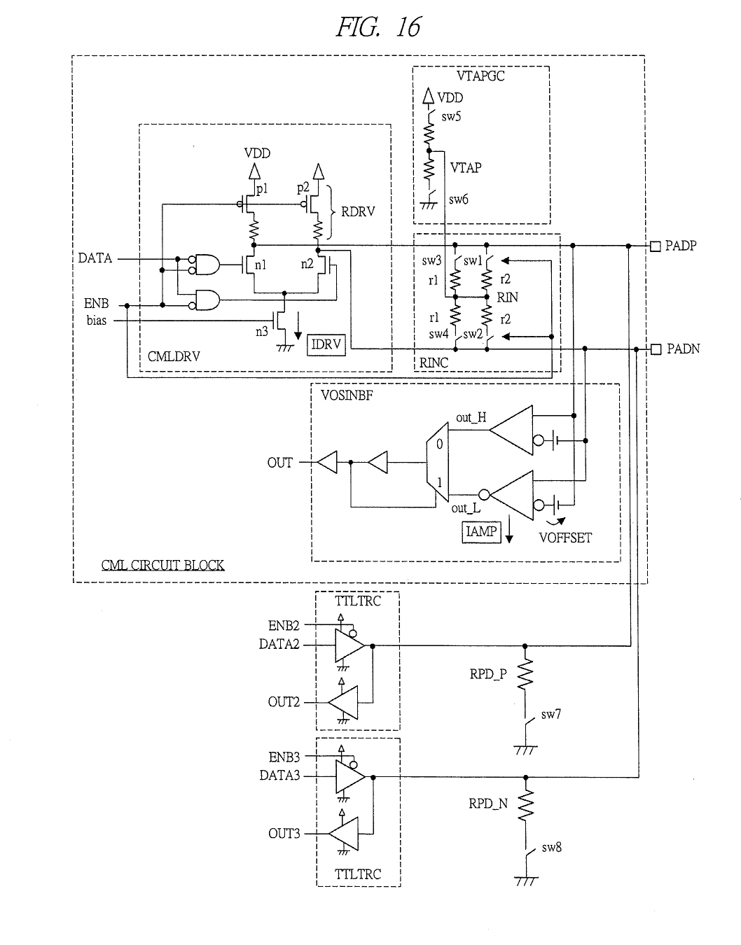

FIGS. 16 to 20 illustrate circuit diagrams and signal waveform diagrams of a configuration with embedded CML circuit and TTL circuit of a more preferable embodiment of the battery pack to which the charging/discharging monitoring device of the present invention is applied. The present embodiment has a feature of a circuit and a signal of the configuration with the embedded CML circuit and TTL circuit. That is, there are four problems to be solved in that (1) it is desired that both of the monitoring integrated circuit IC for the battery measurement (the connection by the capacitive coupling CML method) or the microcontroller unit (the connection by the TTL interface) are handled as a connection destination of a transmission port, (2) it is desired that a standby power in no transmission is suppressed, (3) it is desired that a notification function (notification of the shift from the sleep mode to the normal mode) in transmission restart is provided, (4) it is desired that the number of wire connections between the secondary battery modules is not increased for the notification in the transmission restart (it is desired that a signal (wake-up signal) for the notification of the transmission restart is exchanged by the transmission line for the measurement data).

Therefore, for the above-described item (1), both of the CML circuit and a TTL circuit with pull-down (TTL two-way circuit) are used and controlled, and are used differently depending on the connection destination and the mode. Also, for the above-described item (2), the CML circuit is disable-controlled (to be in the sleep mode) in no transmission so that DC power consumption is suppressed. Further, for the above-described item (3) as the return from the sleep mode, a pulse is transmitted from the TTL circuit to detect the signal. At this time, a pull-down resistor is controlled so that the pulse signal is communicated even in the capacitive coupling system. And, by providing a period in which the signal is masked on the reception side, the shift from the sleep mode to the normal mode in the TTL mode is performed. Still further, for the above-described item (4), the signal is transmitted with using two transmission paths at such timing as no failure of taking-in of the wake-up signal.

More specifically, based on FIG. 16, a CML transmission/reception circuit with a TTL switching function will be explained. A TTL two-way circuit “TTLTRC” is embedded inside a transmission interface circuit, and is exclusively used with the CML circuit. This mechanism has an advantage that, in connection of the monitoring integrated circuit IC to a host computer (microcontroller unit or others), the connection can be easily made to a host having an interface such as a general TTL. In the TTL two-way circuit TTLTRC illustrated in FIG. 16, “DATA” indicates a data input terminal, “ENB” indicates an output enable terminal (L=transmission mode, H=reception mode), and “OUT” indicates a data output terminal. Lines between this TTL two-way circuit TTLTRC and the input/output pads PADP and PADN can be connected/not connected to the GND via pull-down resistors “RPD_P” and “RPD_N” by the ON/OFF control of switches “sw7” and “sw8”.

Note that the reception-end resistance circuit RINC is formed of: two resistors r1 connected in series; switches sw3 and sw4 for connecting the respective resistors r1 to the input/output pads PADP and PADN; two resistors r2 connected in series; and switches sw1 and sw2 for connecting the respective resistors r2 to the input/output pads PADP and PADN, and each connection node between the resistors r1 and between the resistors r2 is connected to the amplitude center potential VTAP. Also, the amplitude-center-potential generating circuit VTAPGC is formed of: two resistors connected in series; and switches sw5 and sw6 for connecting the respective resistors to the VDD and the GND, and the amplitude center potential VTAP is generated at a connection node between the two resistors.

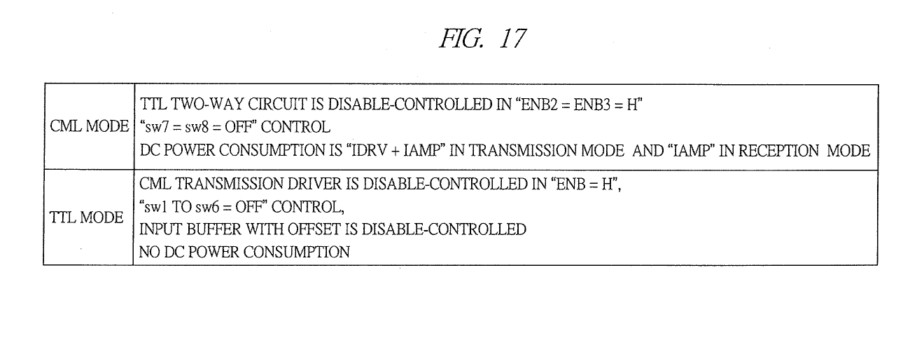

As illustrated in FIG. 17, in the CML mode, the TTL two-way circuit TTLTRC is disable-controlled in a relation of “ENB2=ENB3=H”. At this time, a relation of “sw7=sw8=OFF control” is established. Also, in the TTL mode, the CML transmission driver CMLDRV is disable-controlled in a relation of “ENB=H”. At this time, a relation of “sw1 to sw6=OFF control” is established. Further, the input buffer with offset VOSINBF (input offset “VOFFSET”) is disable-controlled. In this CML mode, there are a direct-current power consumption expressed by “a current IDRV of the CML transmission driver CMLDRV+a current IAMP of the input buffer with offset VOSINBF” in the transmission mode and a direct-current power consumption expressed by “the current IAMP of the input buffer with offset VOSINBF in the reception mode.

Accordingly, when there is no transmission in a certain period of time, the transmission/reception circuit is switched to the TTL mode. In addition, the switches sw7 and sw8 are controlled to be ON. The pull-down resistors RPD_P/RPD_N prevent the input/output pads PADP/PADN from being completely floated, which results in uncertain potential. The current IDRV of the CML transmission driver CMLDRV and the power consumed by the input buffer with offset VOSINBF are cut, and the power consumption is suppressed.

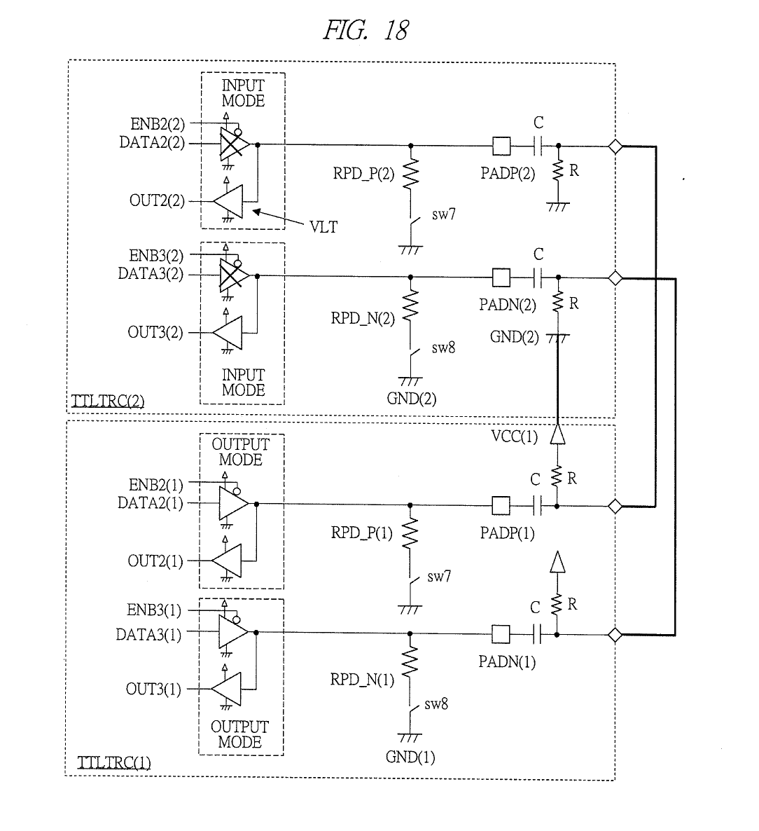

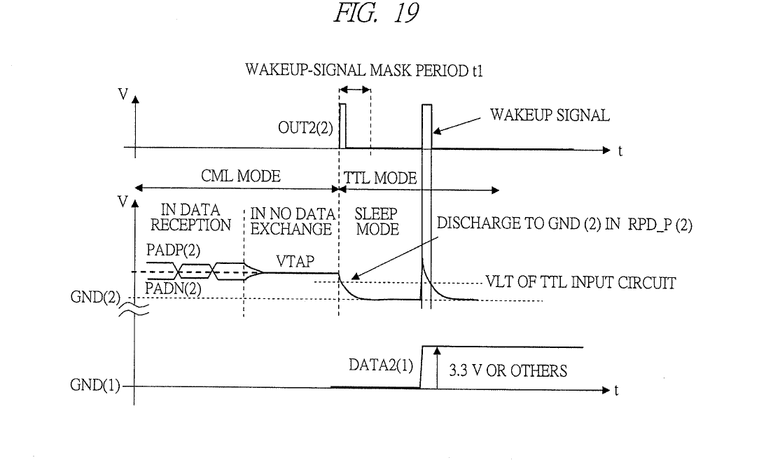

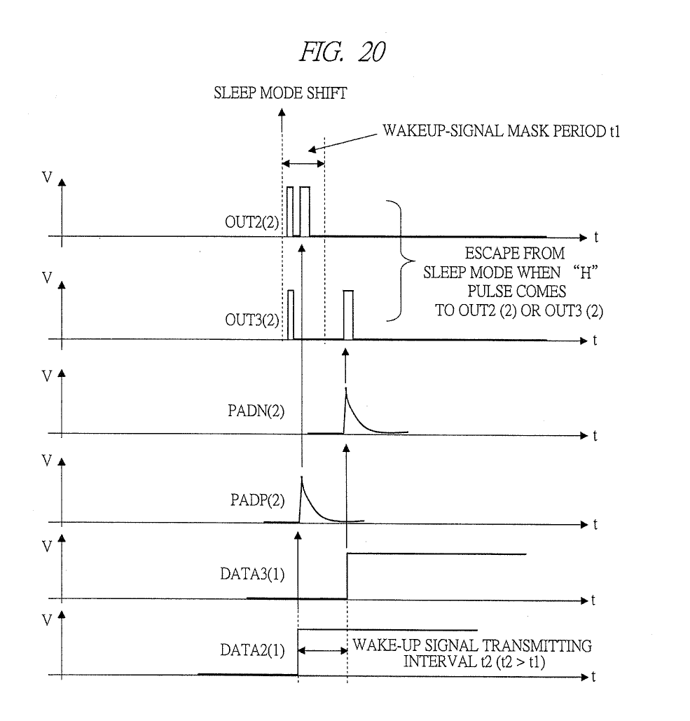

Also, as illustrated in FIG. 18, in the TTL two-way circuit TTLTRC, the input/output pads PADP(1)/PADN(1) of the TTL two-way circuit(1) and the input/output pads PADP(2)/PADN(2) of the TTL two-way circuit(2) are connected to each other with cables, respectively. In such a connecting construction, each signal waveform of the data output terminal OUT2(2), the input/output pads PADP(2)/PADN(2), and the data input terminal DATA2(1) is illustrated in, for example, FIG. 19. That is, immediately after the shift to the sleep mode (a mode with the reduced power consumption), the PADP(2) exceeds the VLT of the TTL input circuit (which is expressed by, for example, “GND(2)+1.4 V” or others) due to a remaining charge in the capacitor C in some cases. In that case, the pulse with the “H” level (for example, 3.3 V or others) is outputted in the OUT2(2) in spite of no output of the wake-up signal (a signal for escaping from the sleep mode) from the DATA2(1), and therefore, the signal is masked in a certain period after the shift to the sleep mode. This masking period can be determined by time constant of a value of the capacitor C and a value of the pull-down resistor RPD_P.

By controlling the pull-down resistor RPD_P(2) to be ON in the sleep mode, the pull-down resistor RPD_P(2) is discharged so as to have the GND(2) so that the potential of the input/output pad PADP(2) is fixed from the amplitude center potential VTAP (which is expressed by, for example, “GND(2)+2.4 V” or others) to the GND(2). Then, it is prepared to receive the wake-up signal. Then, when the wake-up signal rises up, the state escapes from the sleep mode, and such communication as starting up of the amplifier current IAMP is prepared.

Also, FIG. 20 illustrates each signal waveform of the data output terminals OUT2(2) and OUT3(2), the input/output pads PADN (2)/PADP (2), and the data input terminals DATA3(1) and DATA2(1). As illustrated in FIG. 20, for example, when the upstream-side monitoring integrated circuit IC shifts to the sleep mode by a timer or others, if the wake-up signal comes immediately after the shift to the sleep mode, the failure in the taking-in of the signal (OUT2(2)) occurs due to the masking period (t1). Therefore, the wake-up signal is transmitted onto the upstream side with using two transmission paths so as to make a time difference (which is a wake-up signal transmission interval “t2”, t2>t1). Even if the signal on the OUT2(2) side is captured by the masking period, the state can escape from the sleep mode with the signal on the OUT3(2) side. That is, when the “H” pulse comes to the OUT2(2) or the OUT3(2), the state can escape from the sleep mode.

As described above, according to the configuration with the embedded CML circuit and TTL circuit of the present embodiment, the transmission/reception circuit is formed of the CML circuit and the TTL circuit, the CML circuit includes: the input buffer with offset VOSINBF; the amplitude-center-potential generating circuit VTAPGC; the reception-end resistance circuit RINC; and the CML transmission driver CMLDRV, the TTL circuit includes: the TTL two-way circuit TTLTRC which performs the communication with the microcontroller unit or performs the exchange of the wake-up signal; and the pull-down resistor RPD which is between the GND and the input/output end of the TTL two-way circuit TTLTRC so that the connection or no connection to the input/output end of the TTL two-way circuit TTLTRC is controlled, and the CML circuit and the TTL circuit are switched to each other depending on the connection destination and the operation mode of the transmission/reception circuit, so that (1) as the connection destination of the communication port, both of the monitoring integrated circuit IC or the microcontroller can be handled, (2) the standby power in no communication or transmission signal can be suppressed, (3) the notification function in the communication restart can be provided, and (4) the notification in the communication restart can be handled without increasing the number of wire connections between the secondary battery modules MD.

<Communication Protocol>

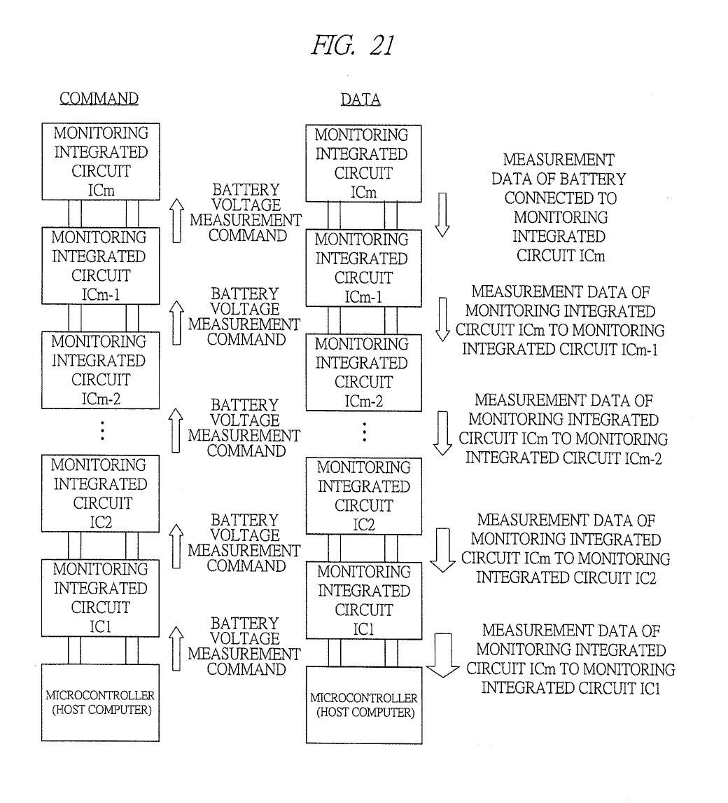

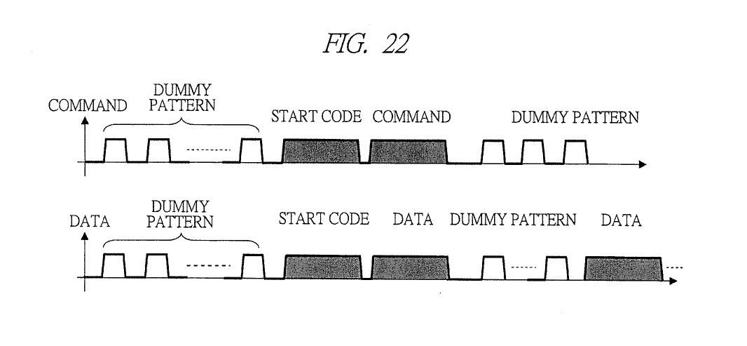

FIGS. 21 and 22 illustrate explanatory diagrams of a communication protocol of a more preferable embodiment of the battery pack to which the charging/discharging monitoring device of the present invention is applied. The present embodiment has a feature of a communication procedure and a signal configuration of the communication protocol. That is, the communication protocol includes “command” and “data”, and the command is issued from the host-computer side and is sequentially communicated to the monitoring integrated circuit IC for the battery measurement located on a side far from the host computer, and the data is transmitted from the monitoring integrated circuit IC located on the side far from the host computer and is sequentially transmitted to the host-computer side with adding the measurement data of itself to the received data. Also, a dummy pattern is inserted into the transmission data so as to balance 0/1 of the data. Further, prior to the command and the data, a start code is inserted for differentiation from the dummy pattern.

More specifically, based on FIG. 21, the communication procedure of the command and the data of the communication protocol will be explained. FIG. 21 illustrates an arrangement in an example of the monitoring integrated circuits IC1 to ICm whose number of circuits is “m” and in which the monitoring integrated circuit IC1 is the closest to the host computer and the monitoring integrated circuit ICm is the farthest from the host computer.

In the command, a battery-voltage measurement command is issued from the microcontroller on the host-computer side first to the monitoring integrated circuit IC1 located on the closest side to the host computer, and then, the battery-voltage measurement command is communicated from the monitoring integrated circuit IC1 to the monitoring integrated circuit IC2 located on the second-closest side to the host computer, and hereinafter, the battery-voltage measurement command is sequentially communicated from the monitoring integrated circuit IC located on the closer side to the host computer to the monitoring integrated circuit IC located on the farther side from the host computer, and at the last, the battery-voltage measurement command is communicated up to the monitoring integrated circuit ICm located on the farthest side from the host computer.

On the other hand, in the data, the measurement data of the battery connected to this monitoring integrated circuit ICm is transmitted from the monitoring integrated circuit ICm located on the farthest side from the host computer to the monitoring integrated circuit ICm−1 located on the second-farthest side from the host computer, and then, the monitoring integrated circuit ICm−1 transmits the received measurement data to the monitoring integrated circuit ICm−2 with adding the measurement data of itself, and hereinafter, the received measurement data is transmitted with adding the measurement data of itself from the monitoring integrated circuit IC located on the farther side from the host computer to the monitoring integrated circuit IC located on the closer side to the host computer, and at the last, all the measurement data of the monitoring integrated circuits ICm to IC1 are transmitted from the monitoring integrated circuit IC1 located on the closest side to the host computer to the microcontroller on the host-computer side.

Also, this communication is performed in the capacitive coupling system with the capacitor C, and therefore, if 0/1 continues in the transmission data, different charges are charged in the capacitive coupling on the positive-phase side and the negative-phase side, which results in the unbalance amplitude. Accordingly, by inserting the dummy pattern with the balanced 0/1 in the data transmission, the charges of the coupling capacities are maintained at a charge amount in an initial state. Further, prior to the command and the data, the start code is inserted for the differentiation from the dummy pattern. That is, as illustrated in FIG. 22, for the command, the start code (for example, 8 bits which are “01000111”) is inserted prior to the command (for example, 8 bits which are bits determined depending on a type of the command), and besides, the dummy pattern (for example, which is obtained by repeating “01” 16 times) is inserted prior to this start code. Also, for the data, the start code (for example, 8 bits which are “01000111”) is inserted prior to the data, and besides, the dummy pattern (for example, which is obtained by repeating “01” 16 times) is inserted prior to this start code.

As described above, according to the communication protocol of the present embodiment, the command issued from the host computer can be sequentially communicated from the monitoring integrated circuit IC located on the closer side to the host computer to the monitoring integrated circuit IC located on the farther side from the host computer. Also, for the data, the measurement data transmitted from the monitoring integrated circuit IC located on the farther side from the host computer is sequentially transmitted with adding the measurement data of itself to the monitoring integrated circuit IC located on the closer side to the host computer, so that the measurement data can be communicated to the host computer. Further, in the transmission of the communication protocol, the dummy pattern is inserted into each of the data and the command to solve the unbalance amplitude, so that the 0/1 of the transmission data can be balanced.

<Configuration of Overvoltage Protection by Zener Diode>

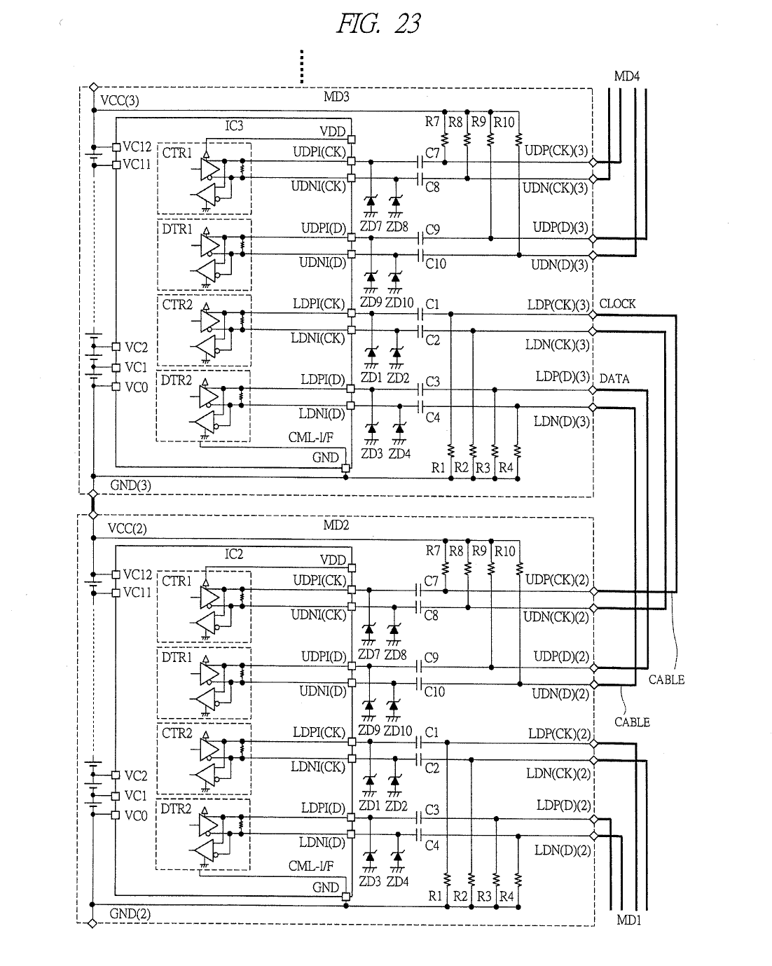

FIG. 23 illustrates a circuit diagram of a configuration of overvoltage protection with zener diodes of a more preferable embodiment of the battery pack to which the charging/discharging monitoring device of the present invention is applied. FIG. 23 illustrates an example of a secondary battery module MD2 and a secondary battery module MD3. The present embodiment has a feature of the circuit configuration of the overvoltage protection with the zener diodes. That is, the configuration is for protecting the application of the overvoltage to the communication terminals in assembling of the secondary battery modules MD or others by connecting zener diodes (ZD) between the communication terminals (UDPI, UDNI, LDPI, and LDNI) and the GND.

More specifically, as illustrated in FIG. 23, outside each of the monitoring integrated circuits IC2 and 103 of the secondary battery modules MD2 and MD3, zener diodes “ZD7” to “ZD10” whose directions are reverse to a direction from each terminal to the GND are connected between the GND and the upstream-side connection communication terminals UDPI (CK) and UDNI (CK) for the clock of these monitoring integrated circuits IC2 and 103 and between the GND and the upstream-side connection communication terminals UDPI(D) and UDNI(D) for the data thereof, respectively. Similarly, zener diodes “ZD1” to “ZD4” whose directions are reverse to a direction from each terminal to the GND are connected between the GND and the downstream-side connection communication terminals LDPI(CK) and LDNI(CK) for the clock of these monitoring integrated circuits IC2 and IC3 and between the GND and the downstream-side connection communication terminals LDPI(D) and LDNI(D) for the data thereof, respectively.

As described above, according to the configuration of the overvoltage protection with the zener diodes of the present embodiment, the zener diodes ZD whose directions are reverse to the direction from each terminal to the GND are connected to the upstream-side connection communication terminals UDPI and UDNI and the downstream-side connection communication terminals LDPI and LDNI which are paired with each other in the monitoring integrated circuit IC with the daisy chain connection, so that the application of the overvoltage to the communication terminals in assembling the secondary battery modules MD or others can be protected.

<One-Way (Single-Way) Communication Method>

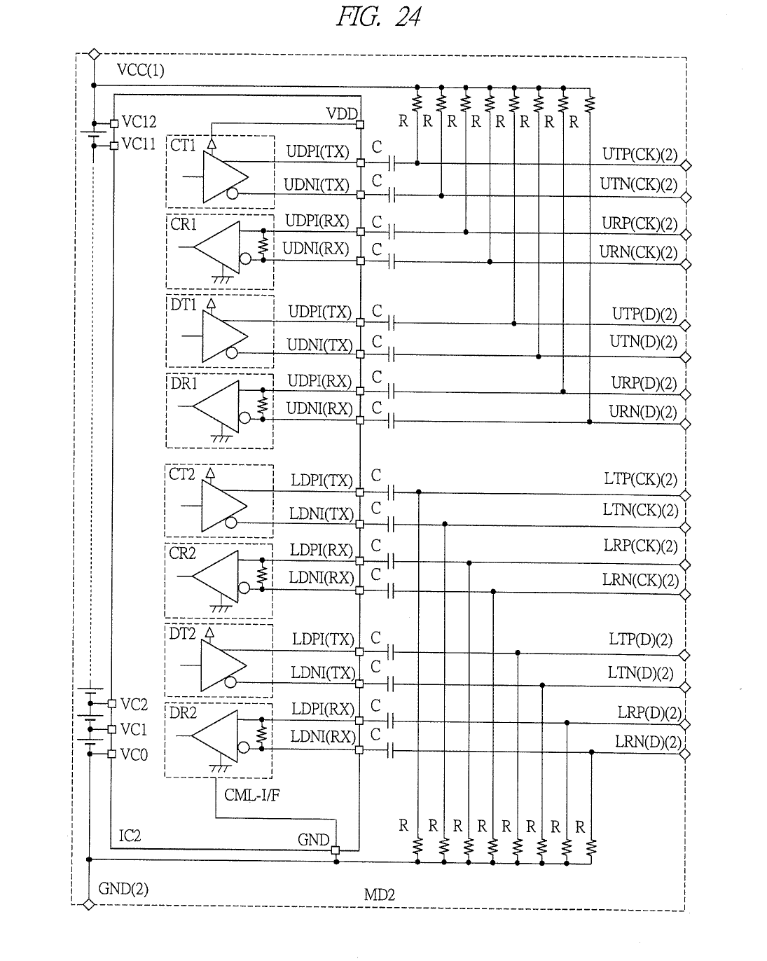

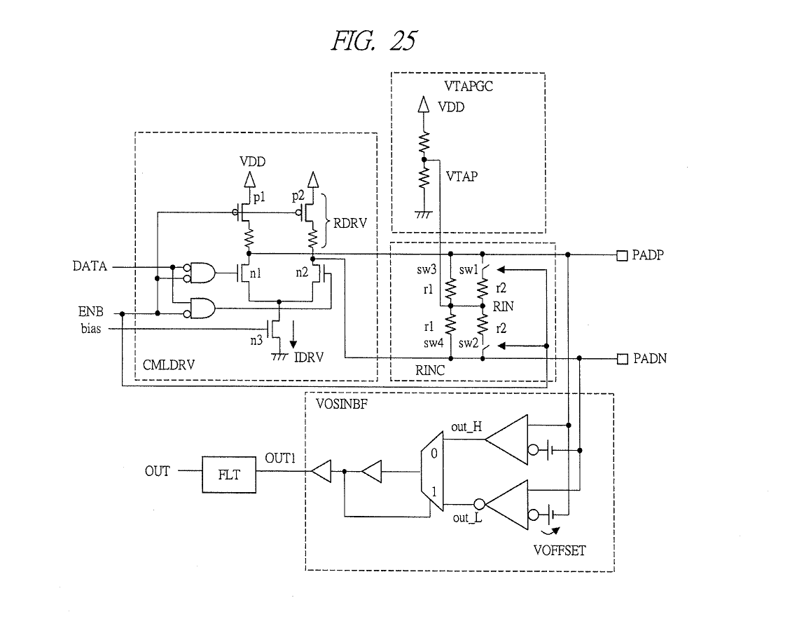

FIG. 24 illustrates a circuit diagram of a one-way communication method of an embodiment of the battery pack to which the charging/discharging monitoring device of the present invention is applied. FIG. 24 illustrates an example of the secondary battery module MD2. The present embodiment has a feature of a circuit configuration of the one-way communication method. That is, by making the communication in one way, while the number of cables between the secondary battery modules is increased, the communications between the downstream-side secondary battery module and the upstream-side secondary battery module can be simultaneously performed. Further, an advantage that the control of the communication interface can be simplified is also provided. Still further, the configuration is advantageous also in the viewpoint of the high speed of the data communication rate.

More specifically, as illustrated in FIG. 24, the monitoring integrated circuit IC2 of the secondary battery module MD2 is configured of: the clock transmission circuit CT1 and the clock reception circuit CR1 to/from the upstream-side secondary battery module MD3; the data transmission circuit DT1 and the reception circuit DR1 to/from the upstream-side secondary battery module MD3; the clock transmission circuit CT2 and the clock reception circuit CR2 to/from the downstream-side secondary battery module MD1; and the data transmission circuit DT2 and the data reception circuit DR2 to/from the downstream-side secondary battery module MD1.

As described above, according to the one-way communication method of the present embodiment, by making the communication directions of the clock and the data be the one-way direction based on the transmission circuit and the reception circuit if the number of pins of the monitoring integrated circuit IC has a margin, the communications between the downstream-side secondary battery module MD and the upstream-side secondary battery module MD can be simultaneously performed, and besides, the control of the communication interface is simplified, and further, the high speed of the data communication rate can be achieved.

<Configuration Enhancing Noise Resistance>

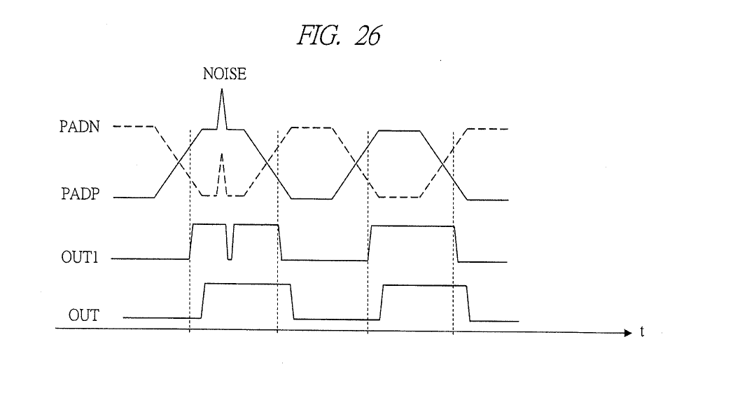

FIGS. 25 and 26 illustrate a circuit diagram and a signal waveform diagram of a configuration enhancing the noise resistance of a more preferable embodiment of the battery pack to which the charging/discharging monitoring device of the present invention is applied. The present embodiment has a feature of the configuration enhancing the noise resistance. That is, since the communication interface of the present invention has adopted the differential configuration, it basically has a resistance against a common mode noise. However, depending on a noise waveform, there is a possibility that the noise affects the output. Accordingly, by inserting a filter circuit for canceling a waveform having a small pulse width in a latter stage, the noise resistance can be enhanced.

More specifically, as illustrated in FIG. 25, in the configuration, a filter circuit “FLT” is connected to an output “OUT1” of the input buffer with offset VOSINBF so that an output “OUT” of this filter circuit FLT is taken in. As illustrated in, for example, FIG. 26, by the configuration with this filter circuit FLT connected, even if the noise (the waveform having the small pulse width) is superimposed on the signal inputted to the input/output pads PADP/PADN, while the noise appears in the output OUT1 of the input buffer with offset VOSINBF, the noise can be removed in the output OUT of this filter circuit FLT by making the signal pass through the filter circuit FLT.

As described above, according to the configuration enhancing the noise resistance of the present embodiment, the filter circuit FLT for removing the noise is connected to the output end of the input buffer with offset VOSINBF, so that the waveform having the small pulse width can be cancelled, and the noise resistance can be enhanced.

[Modification Example of Embodiments]

In the foregoing, the invention made by the present inventors has been concretely described based on the embodiments. However, it is needless to say that the present invention is not limited to the foregoing embodiments and various modifications and alterations can be made within the scope of the present invention.

For example, in the monitoring integrated circuit IC, the reference potential GND may be set as an intermediate voltage (25.2 V in the block 1) corresponded to the negative electrode of the 7th battery cell (E7 in the block 1) from the bottom in the battery cell blocks corresponded to this monitoring integrated circuit IC. In a case of such setting, when the above-described resistors R1 to R6 and R7 to R12 are provided, the blocks are connected so as to be at an intermediate direct-current voltage between the blocks. As described above, the reference voltage of the monitoring integrated circuit IC may be an arbitrary voltage of the battery cell to be connected thereto.

Further, the number of the battery cells provided in one block corresponded to the above-described monitoring integrated circuit IC may be arbitrary. Still further, the number of the blocks configuring the battery pack may be also arbitrary.

Still further, the monitoring integrated circuits IC have the same configuration as each other, and unnecessary circuits may not be used. For example, in FIG. 1, while the data transmission circuit DT2, the data reception circuit DR2, and the clock reception circuit CR2 are mounted on the monitoring integrated circuit IC1 as provided in the monitoring integrated circuit IC2, the interface circuit IF is mounted on the monitoring integrated circuits IC2 to ICm. All the monitoring integrated circuits IC1 to ICm have the completely same configuration as each other.

Still further, the battery cell which is an object to be monitored may be anything as long as it is a secondary battery in addition to the lithium-ion secondary battery. Still further, outside the battery pack, a switch for controlling the charging/discharging operation or a switch for protection may be provided.

The present invention can be widely applied to, for example, an electronic device in which signal transmission between paired semiconductor integrated circuit units each connected to a reference potential or a drive potential different from each other is performed, such as a charging/discharging monitoring device for a battery pack which is formed by connecting a plurality of secondary battery cells in series in multistage.

What is claimed is:

1. A charging/discharging monitoring device configured to monitor charging/discharging of a battery pack, in which a plurality of battery cell sets are connected in series in multistage, the sets each including a plurality of battery cells connected in series, the monitoring device comprising:
a plurality of wiring boards disposed correspondingly to the battery cell sets, the wiring boards each including:
a semiconductor integrated circuit unit including:
a monitoring circuit disposed to the corresponding battery cell set so as to monitor voltage variation of the battery cells in the corresponding battery cell set;
a reception circuit including paired internal connection terminals to which differential data is inputted; and
a transmission circuit including paired internal connection terminals from which differential data is outputted;
external connection terminals provided correspondingly to the internal connection terminals;
capacitors arranged correspondingly to the internal connection terminals so as to electrically connect the internal connection terminals with the corresponding external connection terminals, respectively;
resistors arranged correspondingly to the capacitors, each to have one end connected onto the corresponding external connection terminal and the other end connected to a predetermined potential, and
a plurality of signal transmission paths arranged across between the corresponding wiring boards, each of the signal transmission paths including conductive lines arranged to electrically connect the corresponding external connection terminals so as to connect the plurality of the semiconductor integrated circuit units in a daisy chain connection,
wherein each of the signal transmission paths is configured with:
a first two-wire transmission path through which an output from the semiconductor integrated circuit unit on an upstream side of the daisy chain connection is transmitted via the corresponded capacitor to the semiconductor integrated circuit unit on a downstream side of the daisy chain connection; and
a second two-wire transmission path through which an output from the semiconductor integrated circuit unit on a downstream side of the daisy chain connection is transmitted via the corresponded capacitor to the semiconductor integrated circuit unit on an upstream side of the daisy chain connection, and
wherein a wire length of each wiring part, in which each wiring part connects the capacitor with the corresponding internal connection terminal on the wiring board, is configured to have such a length as to hinder resonance from being caused against electromagnetic wave noises in an electromagnetic wave noise environment under which the wiring board is arranged.

2. The charging/discharging monitoring device according to claim 1,
wherein paired transmission paths in the first and the second two-wire transmission paths through which the differential data is transmitted are arranged so as to be equivalent to each other in potential variation caused by the electromagnetic wave noises.

3. The charging/discharging monitoring device according to claim 1,
wherein, as the predetermined potential applied via the resistor on each of the transmission paths configuring the first and the second two-wire transmission paths, voltages of battery cells are selected so as to be substantially equal to each other.

4. The charging/discharging monitoring device according to claim 1,
wherein, each of the semiconductor integrated circuit units further comprises a potential bias circuit connected to the internal connection terminals to which the differential data is inputted and accommodated to the reception circuit.

5. The charging/discharging monitoring device according to claim 1,
wherein the reception circuit and the transmission circuit are configured as one transmission/reception circuit, the internal connection terminal is configured as paired input/output terminals which are used for both of reception and transmission, and the first and the second two-wire transmission paths are configured as a set of two-wire transmission paths which are used for both, so that two-way transmission/reception transmission is achieved.

6. The charging/discharging monitoring device according to claim 1,
wherein, the set of battery cells connected in series and the corresponding wiring board are formed as a module, and the battery pack is configured by connecting the highest potential of one of the modules to the lowest potential of an upstream-side module and connecting the lowest potential thereof to the highest potential of a downstream-side module, respectively, so that the modules are arranged in the daisy chain connection via the signal transmission paths,
wherein, at the respective modules, the predetermined potentials applied to the resistors in the respective local module are given by connecting the other end of the resistor, which is arranged on the upstream side in the daisy chain connection, to the highest potential in the local module, and by connecting the other end of the resistor, which is arranged on the downstream side in the daisy chain connection, to the lowest potential in the local module.

7. The charging/discharging monitoring device according to claim 1,
wherein, each of the set of battery cells connected in series and the corresponding wiring board are formed as a module, and the battery pack is configured by connecting the highest potential of one of the modules to the lowest potential of an upstream-side module and connecting the lowest potential thereof to the highest potential of a downstream-side module, respectively, so that the modules are arranged in the daisy chain connection via the signal transmission paths,
wherein, at the respective modules, the predetermined potentials applied to the resistors in the respective local module are given by connecting the other end of the resistor, which is arranged on the upstream side in the daisy chain connection, to the highest potential in the local module, and by connecting the other end of the resistor, which is arranged on the downstream side in the daisy chain connection, to a potential within a range between the highest potential and the lowest potential in the local module.

8. The charging/discharging monitoring device according to claim 5,
wherein the transmission/reception circuit includes:
a CML differential circuit;
an input buffer with offset which receives differential data in a reception mode;
an amplitude-center-potential generating circuit which generates a resistive division potential so as to determine an amplitude center in a reception mode;
a reception-end resistance circuit including a reception-end resistance with taking the resistive division potential as a reference; and
a CML transmission driver including a transmission-end resistance which transmits differential data in a transmission mode and configured to equalize the resistive division potential with an amplitude center potential of this differential data,
wherein, in a relation among an impedance ZTX(diff) of the CML transmission driver in a transmission mode, an impedance ZRX(diff) of the reception-end resistance circuit in a reception mode, and a characteristic impedance Z0 of a transmission system, the transmission-end resistance and the reception-end resistance are controlled so that a relation of “ZTX(diff)=ZRX(diff)=2×Z0” is established.

9. The charging/discharging monitoring device according to claim 5,
wherein the transmission/reception circuit comprises:
a CML circuit including:
a CML differential circuit;
an input buffer with offset which receives differential data in a reception mode;
an amplitude-center-potential generating circuit which generates a resistive division potential for determining an amplitude center in a reception mode;
a reception-end resistance circuit including a reception-end resistance with taking the resistive division potential as a reference; and
a CML transmission driver including a transmission-end resistance which transmits differential data in a transmission mode so that an amplitude center potential and the resistive division potential of this differential data are equal to each other, and
a TTL two-way circuit including:
an input/output end which transmits and receives data to/from a connection destination of the transmission/reception circuit;
a pull-down resistor connected between the input/output end and a reference potential; and
a switching unit configured to control a connection status of the pull-down resistor,
wherein the TTL two-way circuit is configured to have a power consumption smaller than a power consumption of the CML circuit, and
wherein the charging/discharging monitoring device is configured to control switching between operating states of the CML circuit and the TTL two-way circuit in accordance with a connection destination and an operation mode of the transmission/reception circuit.

10. The charging/discharging monitoring device according to claim 9,
wherein, when any of the semiconductor integrated circuit units of the daisy chain connection is in a non-transmission state, the transmission/reception circuit of the semiconductor integrated circuit unit is shifted to a sleep mode by disabling the CML circuit, and,
wherein, in the semiconductor integrated circuit unit of the transmission/reception circuit in the sleep mode, the transmission/reception circuit is returned from the sleep mode by enabling the CML circuit in response to a wake-up signal transmitted from the TTL two-way circuit on a downstream side.

11. The charging/discharging monitoring device according to claim 10,
wherein the wake-up signal is transmitted onto the upstream side via the two transmission paths with a time difference, and a mask period is provided on the reception side so as to avoid failure of taking-in of the wake-up signals.

12. The charging/discharging monitoring device according to claim 1,
wherein the semiconductor integrated circuit unit corresponding to the set of battery cells of the battery pack at the lowest stage further includes a control unit which controls communication to/from an external device to be connected to the charging/discharging monitoring device, and
wherein the control unit is configured to control:
to sequentially transmit a command from the external device to the semiconductor integrated circuit units on the upstream side of the daisy chain connection, and
to cause the respective semiconductor integrated circuit unit sequentially transmit measurement data received from the upstream-side semiconductor integrated circuit unit to the downstream-side semiconductor integrated circuit unit with adding measurement data of itself at the local semiconductor integrated circuit unit, and
to transmit the data to the external device.

13. The charging/discharging monitoring device according to claim 12,
wherein the control unit further configured to insert a dummy pattern to the command and the data so that binary 0 and 1 are balanced, and transmit the same.

14. The charging/discharging monitoring device according to claim 1,
wherein, each of the paired terminals of the respective semiconductor integrated circuit unit of the daisy chain connection is connected with a zener diode in a reversed direction to a ground potential.

15. The charging/discharging monitoring device according to claim 8,
wherein a filter circuit which removes noises is connected to an output end of the input buffer with offset.

16. A charging/discharging monitoring device configured to monitor charging/discharging of a battery pack, in which a plurality of battery cell sets are connected in series in multistage, the sets each including a plurality of battery cells connected in series, the monitoring device comprising:
a circuit unit including:
a semiconductor integrated circuit including:
a monitoring circuit disposed to the corresponding battery cell set so as to monitor voltage variation of the battery cells in the corresponding battery cell set;
a reception circuit including paired internal connection terminals to which differential data is inputted; and
a transmission circuit including paired internal connection terminals from which differential data is outputted;
external connection terminals provided correspondingly to the internal connection terminals;
capacitors arranged correspondingly to the internal connection terminals so as to electrically connect the internal connection terminals with the corresponding external connection terminals, respectively;
resistors arranged correspondingly to the capacitors, each to have one end connected onto the corresponding external connection terminal and the other end connected to a predetermined potential, and
a plurality of signal transmission paths arranged across between the corresponding circuit units, each of the signal transmission paths including conductive lines arranged to electrically connect the corresponding external connection terminals so as to connect the plurality of the semiconductor integrated circuits in daisy chain connection,
wherein each of the signal transmission paths is configured with:
a first two-wire transmission path through which an output from the semiconductor integrated circuit on an upstream side of the daisy chain connection is transmitted via the corresponded capacitor to the semiconductor integrated circuit on a downstream side of the daisy chain connection; and
a second two-wire transmission path through which an output from the semiconductor integrated circuit on a downstream side of the daisy chain connection is transmitted via the corresponded capacitor to the semiconductor integrated circuit on an upstream side of the daisy chain connection, and
wherein a wire length of each wiring part, in which each wiring part connects the capacitor with the corresponding internal connection terminal, is configured to have such a length as to hinder resonance from being caused against electromagnetic wave noises in an electromagnetic wave noise environment under which the circuit unit is arranged.

17. A battery pack in which charging/discharging of battery cells connected in series is monitored by the charging/discharging monitoring device according to claim 1,
wherein each of the set of battery cells connected in series and the corresponding wiring board are formed as a module, and the battery pack is configured by connecting the highest potential of one of the modules to the lowest potential of an upstream-side module and connecting the lowest potential thereof to the highest potential of a downstream-side module, respectively, so that the modules are arranged in the daisy chain connection via the signal transmission path, and
wherein, at the respective modules, the predetermined potentials applied to the resistors in the respective local module are given by connecting the other end of the resistor, which is arranged on the upstream side in the daisy chain connection to the highest potential in the module, and by connecting the other end of the resistor, which is arranged on the downstream side in the daisy chain connection, to the lowest potential or a potential within a range between the highest potential and the lowest potential in the local module.

18. A monitoring device for a battery system comprising:
a plurality of circuit units arranged correspondingly to serially connected battery cells, each of the units comprising:
a semiconductor integrated circuit having a monitoring circuit configured to monitor a voltage variation of the corresponding battery cells; a reception circuit configured to receive differential data; and a transmission circuit configured to output differential data;
external connection terminals;
capacitors arranged so as to electrically couple internal connection terminals on the semiconductor integrated circuit with the corresponding external connection terminals, respectively;
resistors arranged correspondingly to the capacitors and each having one end connected to the corresponding external connection terminal and the other end connected to a predetermined potential,
signal transmission paths each configured with two-wire transmission lines connected to the corresponding external connection terminals, the signal transmission paths being arranged among the circuit units so as to connect the plurality of semiconductor integrated circuits in daisy chain connection, and
a control unit coupled to the signal transmission paths at the lowest stage of the daisy chain connection and configured to control:
transmitting a command to the respective circuit units sequentially from the lower stage to the upper stage in the daisy chain connection, and
causing the respective circuit units to transmit measurement data relating to the battery cells sequentially from the upper stage to the lower stage in the daisy chain connection such that the respective local circuit unit receives measurement data from the circuit unit of the upper stage, adds local measurement data to the received data, and transmit the data thus obtained to the circuit unit of the lower stage,
wherein a length of each wiring part that connects the capacitor with the corresponding internal connection terminal, is configured to have such a length as to hinder resonance from being caused against electromagnetic wave noises in an electromagnetic wave noise environment under which the circuit unit is operated.
